(19) United States
(12) Patent Application Publication
(10) Pub. No.: US 2020/0175693 A1
(43) Pub. Date: Jun. 4, 2020

(54) IMAGE PROCESSING DEVICE, IMAGE PROCESSING METHOD, AND PROGRAM

(71) Applicant: SONY CORPORATION, TOKYO (JP)

(72) Inventors: SHINICHI TAKADA, KANAGAWA (JP); KENICHIRO OI, KANAGAWA (JP); HIRONAGA SANO, KANAGAWA (JP)

(21) Appl. No.: 15/774,040

(22) PCT Filed: Oct. 11, 2016
(86) PCT No.: PCT/JP2016/080092

§ 371 Date: May 7, 2018

(30) Foreign Application Priority Data
Nov. 20, 2015 (JP) 2015-227183

(51) Int. Cl. G06T 7/20; G06K 9/00; G06T 7/11; G06T 7/136

(52) U.S. Cl. CPC G06T 7/20; G06K 9/00778; G06T 7/11; G06T 2207/30242; G06T 2207/30196; G06T 2207/20081; G06T 7/136

(57) ABSTRACT

A threshold map generation unit 412 partitions a captured image into a crowded region and an uncrowded region on a basis of a manipulation signal from an input device 30, acquires a human determination threshold in accordance with a level of crowdedness for each region from the threshold storage unit 411, and generates a threshold map. A human detection unit 421 performs human detection using the human determination threshold corresponding to the region for each of the plurality of regions on the basis of the threshold map. A tracking unit 422 performs tracking of detected humans. A human detection reliability calculation unit 441 calculates human detection reliability for each of the detected humans using a human detection result and a tracking result. Accordingly, it is possible to obtain human detection information with high reliability and high precision.

### TECHNICAL FIELD

The present technology relates to an image processing device, an image processing method, and a program capable of obtaining human detection information with high reliability and high precision.

### BACKGROUND ART

In the related art, technologies for detecting humans from images generated by imaging devices and counting the detected humans have been disclosed. For example, in Patent Literature 1, trajectories of human tracking positional information are supplied to a filter unit and humans are counted from the number of trajectories (human trajectories) of the selected human positional information selected in the filter unit. In addition, the filter unit adjusts filtering parameters so that the number of approaching human trajectories along which humans approach among the trajectories of the human positional information is substantially the same as the number of trajectories of face positional information and selects human tracking position information.

### CITATION LIST

### Patent Literature

Patent Literature 1: JP 2013-206018A

### DISCLOSURE OF INVENTION

### Technical Problem

Incidentally, in a case in which humans are detected from images generated by imaging devices, overlap of humans is small in images in which regions where the humans are not crowded are imaged. Accordingly, highly precise human detection is possible. However, when regions in which humans are crowded are imaged, an occurrence frequency of overlap of the humans increases in images in which the regions are imaged, and thus it may be difficult to detect individual humans with high precision.

Accordingly, the present technology provides an image processing device, an image processing method, and a program capable of obtaining a human detection result with high reliability and high precision.

### Solution to Problem

According to a first aspect of the present technology, there is provided an image processing device including: a threshold map generation unit configured to generate a threshold map in which a human determination threshold is set for each of a plurality of regions obtained by partitioning a captured image; a human detection unit configured to perform human detection using the human determination threshold corresponding to the region for each of the plurality of regions on a basis of the threshold map generated by the threshold map generation unit; a tracking unit configured to perform tracking of humans detected by the human detection unit; and a human detection reliability calculation unit configured to calculate human detection reliability for each of the detected humans by using a human detection result of the human detection unit and a tracking result of the tracking unit.

In the present technology, the captured image is partitioned into the crowded region and the uncrowded region through a user manipulation or on the basis of a crowdedness level detection result of the captured image. The threshold map generation unit generates the threshold map indicating the human determination threshold for each region using the human determination threshold in accordance with the level of crowdedness of the region. The human determination threshold of the crowded region is set such that a precision ratio indicating to what extent humans of the crowded region are included in the humans detected through the human detection is maximum in a state in which a recall ratio indicating to what extent the humans detected through the human detection are included in the humans of the crowded region is maintained at a predetermined level. In addition, the human determination threshold of the uncrowded region is set such that a precision ratio indicating to what extent humans of the uncrowded region are included in the humans detected through the human detection is equal to or greater than a predetermined level and a recall ratio indicating to what extent the humans detected through the human detection are included in the humans of the uncrowded region is maximum. The human determination threshold is set in advance by the threshold learning unit using, for example, learning images of the crowded region and the uncrowded region.

The human detection unit calculates a score indicating accuracy of the humans with regard to a subject and determines that the subject is a human when the calculated score is equal to or greater than the human determination threshold corresponding to a position of the subject of the threshold map. The tracking unit sets tracking frames on the humans detected by the human detection unit and predicts positions of the tracking frames in a captured image having a different imaging time from images within the tracking frames, by using the captured image having the different imaging time. In addition, the tracking unit sets different pieces of tracking identification information for each human with regard to the tracking frames, predicts a position of the tracking frame for each piece of the tracking identification information, and includes the piece of the tracking identification information set in the tracking frame at the predicted position in information indicating a human detection result obtained by the human detection unit within a human position assumption region corresponding to the tracking frame at the predicted position. The human detection reliability calculation unit calculates the human detection situation at the tracked position during the reliability calculation period for each of the detected humans using a human detection result of the human detection unit and a tracking result of the tracking unit and sets the human detection situation as the human detection reliability.

In addition, the image processing device includes a threshold adjustment unit configured to adjust the human determination threshold of a predetermined region in which a predicted position of a human in the threshold map serves as a reference such that it becomes easier to determine the human than before the adjustment, when the human detected in the uncrowded region is tracked by the tracking unit and the predicted position of the human is in the crowded region.

In addition, the image processing device includes a backtracking unit configured to adjust the human determination threshold of a predetermined region in which a predicted position of a human in the threshold map serves as a reference such that it becomes easier to determine the human than before the adjustment, when tracking and human detection are performed on the human detected in the uncrowded region in a past direction and the predicted position of the human in the tracking is in the crowded region, and configured to perform the human detection using the adjusted human determination threshold. In addition, in the case where the image processing device includes the backtracking unit, the human detection reliability calculation unit calculates the human detection reliability by using a tracking result and a human detection result acquired by the backtracking unit. Further, the image processing device further includes a counting unit configured to set humans for which the human detection reliability is equal to or greater than a counting target determination threshold and who pass a preset counting position on a basis of the human detection reliability calculated by the human detection reliability calculation unit and a tracking result of the tracking unit as counting targets and count the number of humans passing the counting position.

According to a second aspect of the present technology, there is provided an image processing method including: generating, by a threshold map generation unit, a threshold map in which a human determination threshold is set for each of a plurality of regions obtained by partitioning a captured image; performing, by a human detection unit, human detection using the human determination threshold corresponding to the region for each of the plurality of regions on a basis of the threshold map generated by the threshold map generation unit; performing, by a tracking unit, tracking of humans detected by the human detection unit; and calculating, by a human detection reliability calculation unit, human detection reliability for each of the detected humans by using a human detection result of the human detection unit and a tracking result of the tracking unit.

In addition, according to a third aspect of the present technology, there is provided a program causing a computer to perform image processing, the program causing the computer to perform: a procedure for generating a threshold map in which a human determination threshold is set for each of a plurality of regions obtained by partitioning a captured image; a procedure for performing human detection using the human determination threshold corresponding to the region for each of the plurality of regions on a basis of the generated threshold map; a procedure for performing tracking of the detected humans; and a procedure for calculating human detection reliability for each of the detected humans by using a result of the human detection and a result of the tracking.

Note that the program according to the present technology is, for example, a program that can be provided in a general-purpose computer capable of executing various program codes on a storage medium or a communication medium provided in a computer-readable format, for example, a storage unit such as an optical disc, a magnetic disk, or a semiconductor memory or a communication medium such as a network. A process in accordance with the program can be realized on a computer by providing the program in a computer-readable format.

### Advantageous Effects of Invention

According to the present technology, a threshold map in which a human determination threshold is set in each of a plurality of regions into which a captured image is partitioned is generated and human detection is performed based on the threshold map by using the human determination threshold corresponding to the region for each of the plurality of regions. In addition, detected humans are tracked and human detection reliability is calculated for each of the detected humans by using a human detection result and a tracking result. Accordingly, it is possible to obtain human detection information with high reliability and high precision. Moreover, the effects described herein are merely illustrative but not restrictive, or there may be additional advantageous effects.

### BRIEF DESCRIPTION OF DRAWINGS

FIG. 1 is a diagram exemplifying a configuration of an image processing system.

FIG. 2 is a diagram illustrating a configuration according to a first embodiment.

FIG. 3 is an explanatory diagram illustrating generation of a threshold map.

FIG. 4 is an explanatory diagram illustrating a precision ratio and a recall ratio.

FIG. 5 is a diagram exemplifying a relation between scores of the precision ratio and the recall ratio.

FIG. 6 is a diagram exemplifying human detection results at different times.

FIG. 7 is a diagram exemplifying tracking results and human detection results.

FIG. 8 is a diagram exemplifying an operation of a counting unit.

FIG. 9 is a flowchart illustrating an operation according to the first embodiment.

FIG. 10 is a flowchart illustrating a threshold map generation process.

FIG. 11 is a flowchart illustrating a human detection information generation process.

FIG. 12 is a diagram illustrating a case in which a human is moving from an uncrowded region to a crowded region.

FIG. 13 is a diagram illustrating a configuration according to a second embodiment.

FIG. 14 is an explanatory diagram illustrating an operation of adjusting a human determination threshold.

FIG. 15 is a flowchart illustrating a human detection information generation process according to the second embodiment.

FIG. 16 is a diagram illustrating a case in which a human is moving from a crowded region to an uncrowded region.

FIG. 17 is a diagram illustrating a configuration according to a third embodiment.

FIG. 18 is a diagram illustrating a configuration of a backtracking unit.

FIG. 19 is a diagram illustrating an operation of a backtracking unit.

FIG. 20 is a flowchart illustrating a human detection information generation process according to the third embodiment.

FIG. 21 is a flowchart illustrating a backtracking process.

FIG. 22 is a diagram illustrating a configuration according to a fourth embodiment.

FIG. 23 is an explanatory diagram illustrating a learning method for a human determination threshold (a crowded region).

FIG. 24 is an explanatory diagram illustrating a learning method for a human determination threshold (an uncrowded region).

FIG. 25 is a flowchart illustrating an operation according to the fourth embodiment.

FIG. 26 is a flowchart illustrating a threshold learning process.

FIG. 27 is a diagram illustrating a configuration according to another embodiment.

FIG. 28 is a flowchart illustrating an operation according to the other embodiment.

### MODE(S) FOR CARRYING OUT THE INVENTION

Hereinafter, modes for carrying out the present technology will be described. Note that the description will be made in the following order.
1. Image processing system
2. First Embodiment
3. Second Embodiment
4. Third Embodiment
5. Fourth Embodiment
6. Other embodiments

### 1. Image Processing System

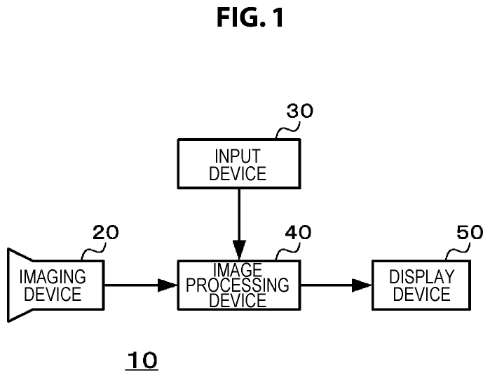

FIG. 1 is a diagram exemplifying a configuration of an image processing system. An image processing system 10 includes an imaging device 20, an input device 30, an image processing device 40, and a display device 50.

The imaging device 20 images a place in which humans are moving and generates a captured image. The captured image includes a region in which crowding easily occurs (hereinafter referred to as a “crowded region”) and another region (hereinafter referred to as an “uncrowded region”). For example, in a captured image obtained by imaging a connection portion of a passage with a narrow width and a passage with a broad width or a place in which a gate or the like is installed, an imaged region obtained by imaging such a place is equivalent to a crowded region in a case in which humans moving through the passage with the narrow width or humans passing through the gate increase. The imaging device 20 outputs an image signal of the generated captured image to the image processing device 40.

The input device 30 includes a manipulation key a manipulation lever, a touch panel, or the like receives a user manipulation, and outputs a manipulation signal in accordance with the user manipulation to the image processing device 40.

The image processing device 40 generates a threshold map in which a human determination threshold is set in each of a plurality of regions obtained by partitioning the captured image generated by the imaging device 20. In addition, the image processing device performs human detection using the human determination threshold corresponding to a region for each region on the basis of the generated threshold map. In addition, the image processing device 40 performs tracking of detected humans and calculates human detection reliability of each of the detected humans using the human detection result and the tracking result. Further, the image processing device 40 counts the number of humans passing a preset determination position on the basis of a tracking result and the human detection reliability. In addition, the image processing device 40 outputs information acquired from the captured image, for example, a signal indicating a counting result or the like, to the display device 50 so that the information or the like acquired by the image processing device 40 is displayed on a screen.

### 2. First Embodiment

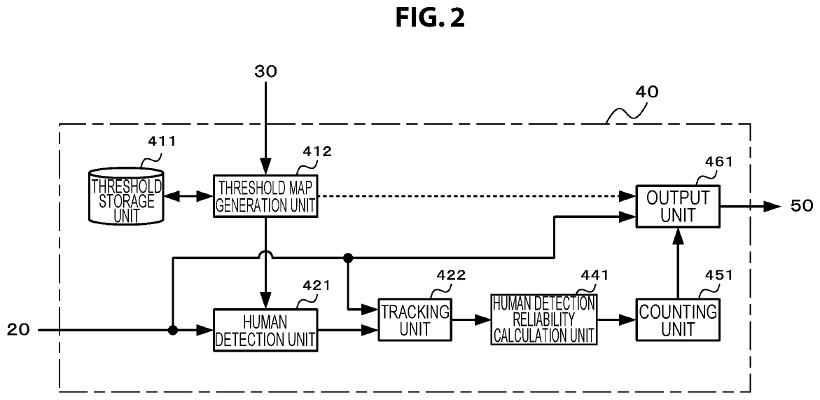

FIG. 2 is a diagram illustrating a configuration of a first embodiment of the image processing device according to the present technology. The image processing device 40 includes a threshold storage unit 411, a threshold map generation unit 412, a human detection unit 421, a tracking unit 422, a human detection reliability calculation unit 441, a counting unit 451, and an output unit 461.

The threshold storage unit 411 stores a human determination threshold in advance at each level of crowdedness. As will be described below, the human determination threshold is used as a determination reference when the human detection unit 421 performs human determination. The threshold storage unit 411 outputs the human determination threshold in accordance with the level of crowdedness indicated in the threshold map generation unit 412 to be described below to the threshold map generation unit 412.

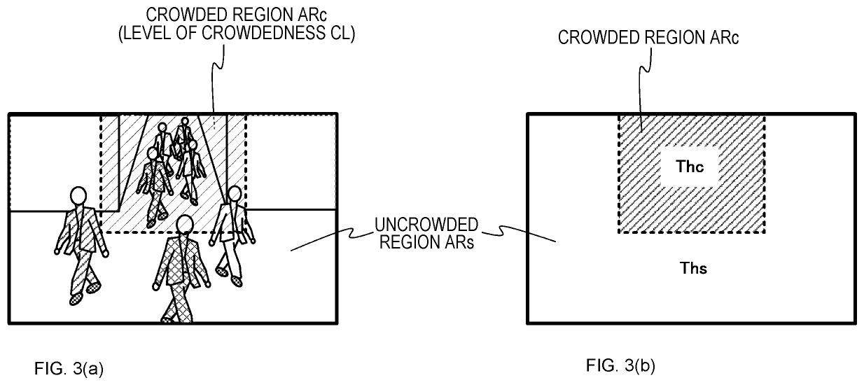

The threshold map generation unit 412 generates a threshold map in accordance with a preset crowded region and uncrowded region and the level of crowdedness of the crowded region. The threshold map generation unit 412 partitions a captured image generated by the imaging device 20 into a plurality regions with different levels of crowdedness in advance on the basis of a manipulation signal supplied from the input device 30 in response to a user manipulation. In the partitioning into the regions, in the image processing device 40, the captured image generated by the imaging device 20 is output, for example, from the output unit 461 to be described below to the display device 50 so that the captured image is displayed. A user performs a manipulation of partitioning the captured image into the plurality of regions with the different levels of crowdedness using the captured image displayed on the display device 50. The threshold map generation unit 412 partitions the captured image into crowded regions and uncrowded regions on the basis of the manipulation signal indicating the region partitioning manipulation. FIG. 3 is an explanatory diagram illustrating generation of a threshold map. (a) of FIG. 3 exemplifies a captured image generated by the imaging device 20. A region indicated by diagonal lines is a crowded region ARc and the other region is an uncrowded region ARs.

In addition, the threshold map generation unit 412 acquires the human determination threshold from the threshold storage unit 411 in response to a level of crowdedness designation manipulation on the partitioned regions by the user and generates the threshold map. For example, the user performs a manipulation of designating the levels of crowdedness on the partitioned regions. Note that a level of crowdedness CL is designated on the crowded region ARc in (a) of FIG. 3. The threshold map generation unit 412 notifies the threshold storage unit 411 of the designated level of crowdedness on the basis of the level of crowdedness designation manipulation. Further, the threshold map generation unit 412 acquires the human determination threshold stored in the threshold storage unit 411 in accordance with the notification of the level of crowdedness and generates a threshold map by associating the acquired threshold with the partitioned region. (b) of FIG. 3 exemplifies the threshold map. As illustrated in (a) of FIG. 3, in a case in which the user designates the level of crowdedness CL for the crowded region ARc, the threshold map generation unit 412 acquires a human determination threshold Thc corresponding to the level of crowdedness CL from the threshold storage unit 411 and sets the human determination threshold Thc in the crowded region ARc. In addition, the threshold map generation unit 412 sets the other region except for the crowded region as the uncrowded region ARs and sets, for example, a human determination threshold for the uncrowded region ARs to a human determination threshold Ths set in advance. Note that the uncrowded region ARs is not limited to the threshold set in advance, and the user may set a level of crowdedness of the uncrowded region ARs and acquires the human determination threshold Ths corresponding to the set level of crowdedness from the threshold storage unit 411. In this way, the threshold map generation unit 412 generates the threshold map indicating the crowded region and the uncrowded region in the captured image generated by the imaging device 20 and the human determination threshold for each region in response to the user manipulation in advance and outputs the threshold map to the human detection unit 421.

The human detection unit 421 performs human detection using the captured image generated by the imaging device 20. In the human detection, a score indicating likelihood of humans is calculated. In addition, the human detection unit 421 compares the human determination threshold corresponding to each region with a score of a subject in the region for each region indicated with the threshold map generated by the threshold map generation unit 412 and determines a subjects with the scores equal to or greater than the human determination threshold as humans. The human detection unit 421 outputs human detection positions indicating the positions of the subjects determined to be the humans as a human detection result to the tracking unit 422.

The human detection unit 421 uses a feature amount based on gradient information, a feature amount based on color information, and a feature amount based on a motion in the human detection. The feature amount based on the gradient information is, for example, a histograms of oriented gradients (HOG) feature amount, an edge orientation histograms (EOG) feature amount, or the like. The feature amount based on the color information is, for example, an integral channel features (ICF) feature amount, a color self similarity (CSS), or the like. The feature amount based on the motion is, for example, a Haar-like feature amount, a histograms of flow (HOF) feature amount, or the like. The human detection unit 421 calculates a score indicating likelihood of humans using these features.

The human determination threshold is set such that the precision ratio is a constant value or more and a recall ratio is the maximum in an uncrowded region, and the precision ratio is the maximum in a state in which the recall ratio is maintained constantly in a crowded region. The recall ratio indicates to which extent humans detected in the human detection are included in the humans included in the captured image. In addition, the precision ratio indicates to which extent the humans included in the captured image are included in the humans detected in the human detection.

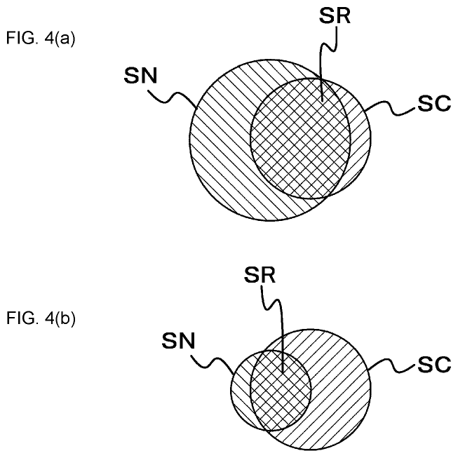

FIG. 4 is an explanatory diagram illustrating a precision ratio and a recall ratio. In FIG. 4, a set SN indicates the number of human detection results, a set SC indicates a correct number of humans shown in the captured image, and a common portion SR of the set SN and a set SC indicates a correct number (the number of humans correctly detected) in a number of a human detection result. The precision ratio Rpre and the recall ratio Rrec can be calculated by performing an arithmetic operation of “Rpre=(SR/SN)” and “Rrec=(SR/SC).”

Here, when the human determination threshold is set to be small so that omission of the human detection is small, as illustrated in (a) of FIG. 4, the precision ratio Rpre decreases and the recall ratio Rrec is near “1.” In addition, when the human determination threshold is set to be large so that precision of the human detection is high, as illustrated in (b) of FIG. 4, the precision ratio Rpre is near “1” and the recall ratio Rrec is less than in (a) of FIG. 4.

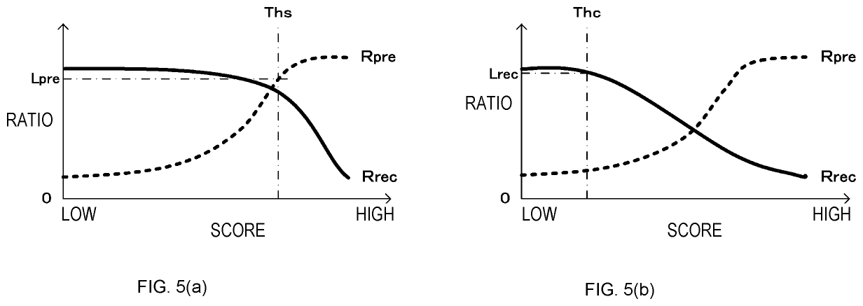

FIG. 5 is a diagram exemplifying a relation among the precision ratio, the recall ratio, and scores. Note that (a) of FIG. 5 exemplifies the case of an uncrowded region and (b) of FIG. 5 exemplifies the case of a crowded region. In the uncrowded region ARs, the human determination threshold Ths is set such that the precision ratio Rpre is equal to or greater than a certain constant value Lpre and the recall ratio Rrec is the maximum. In the crowded region ARc, missing is easy in the human detection. Therefore, the human determination threshold Thc is set such that the precision ratio Rpre is the maximum in a state in which the recall ratio Rrec is maintained at the certain constant value Lrec. In addition, when the human determination threshold Thc is set such that the precision ratio Rpre is the maximum in the state in which the recall ratio Rrec is maintained at the certain constant value Lrec, as illustrated in (b) of FIG. 5, the precision ratio Rpre becomes a low value, and thus there is a concern of erroneous human detection increasing. For this reason, erroneous detection is excluded from the human detection result using human detection reliability to be described below.

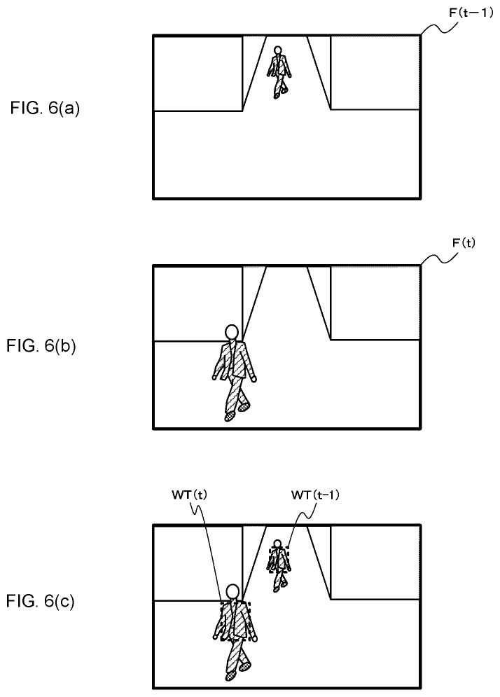

The tracking unit 422 performs tracking humans on the basis of the human detection result supplied from the human detection unit 421. FIG. 6 exemplifies human detection results at different times. (a) of FIG. 6 exemplifies a captured image F(t−1) at time (t−1) and (b) of FIG. 6 exemplifies a captured image F(t) at time (t). The tracking unit 422 sets a tracking frame for a detected human for each human on the basis of the human detection result. For example, in a case in which a head is detected through the human detection, the tracking frame is set as a rectangular state so that a body part of the detected head is included, for example, in order to easily perform the tracking using human features. In this way, when the tracking frame is set so that the body part is included, the human tracking can be easily performed using features of body parts such as a difference in a physique, a difference in costume, and a difference in the color of the costume. In addition, the tracking unit 422 sets tracking identification information in the tracking frame so that individual humans can be distinguished in accordance with the tracking identification information.

For example, as illustrated in (c) of FIG. 6, the tracking unit 422 predicts the position of a tracking frame WT(t) corresponding to the captured image F(t) from an image at the position of a tracking frame WT(t−1) set in the captured image F(t−1) at time (t−1) and the captured image F(t) at time (t). The tracking unit 422 includes the tracking identification information set in the tracking frame in information indicating a predicted position of the tracking frame and sets the tracking identification information as a tracking result.

Further, the tracking unit 422 outputs a pair of the predicted tracking frame and the human detection result corresponding to the tracking frame to the human detection reliability calculation unit 441. For example, as described above, in a case in which the tracking frame is set in the body part in this way, the tracking is performed, and the head is detected in the human detection, the position of the head can be assumed in the tracking frame. Therefore, a region in which the head is assumed to be located is set as a human position assumption region corresponding to the tracking frame. Here, when the position of the head detected in the human detection is the human position assumption region, the human detection result and the predicted tracking frame are paired and the tracking identification information set in the predicted tracking frame is assumed to be allocated in the human detection result, for example. In addition, the tracking unit 422 adjusts the position of the tracking frame in accordance with the position of the detected head and continues the tracking. In this way, when the position of the tracking frame is adjusted in accordance with the position of the detected head, an error is not accumulated even when the error occurs at the time of prediction of the position of the tracking frame. Therefore, the tracking can be performed with high precision.

The human detection reliability calculation unit 441 calculates the human detection reliability using the tracking result and the human detection result. The human detection reliability calculation unit 441 retains histories of the position of the tracking frame and the human detection result and calculates a ratio of the tracking frame in which the humans are detected in, for example, a tracking frame of a reliability calculation period for each piece of tracking frame identification information as a human detection reliability using the retained histories. The human detection reliability calculation unit 441 sets a ratio of the tracking frame in which the human detection and the position of the tracking frame are paired as the human detection reliability, for example, in the tracking frame of a predetermined frame period in a direction from the present time to the past time for each piece of tracking identification information. The human detection reliability calculation unit 441 outputs the calculated human detection reliability to the counting unit 451. For the human detection reliability calculated in this way, the human detection reliability increases with an increase in a ratio of a frame in which the humans are detected. Thus, when the human detection reliability is high, reliability of the human detection result is assumed to be high.

Note that the tracking unit 422 and the human detection reliability calculation unit 441 may perform the tracking and the calculation of the human detection reliability using a captured image at a predetermined frame interval without being limited to the case in which the tracking and the calculation of the human detection reliability are performed using a captured image of continuous frames. For example, in a case in which a motion of a subject is slow, a difference in an image between frames adjacent in a time direction is small. Therefore, by using a captured image at a predetermined frame interval, it is possible to efficiently perform the tracking and the calculation of the human detection reliability.

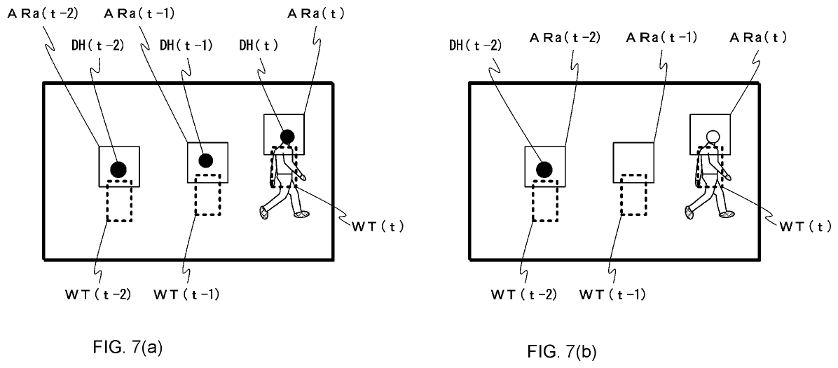

FIG. 7 is a diagram exemplifying tracking results and human detection results. (a) of FIG. 7 illustrates a case in which humans are detected in the human position assumption region corresponding to a tracking frame in which the tracking identification information is the same, for example, at time t−2, t−1, and t. (b) of FIG. 7 exemplifies a case in which humans are detected in the human position assumption region corresponding to the tracking frame, for example, only at time t−2 and humans are not detected in the human position assumption region corresponding to the tracking frame at times t−1 and t. Note that a tracking frame at time t−2 is indicated by “WT(t−2),” a tracking frame at time t−1 is indicated by “WT(t−1),” and a tracking frame at time t is indicated by “WT(t).” In addition, a human position assumption region corresponding to the tracking frame WT(t−2) is indicated by “ARa(t−2),” a human position assumption region corresponding to the tracking frame WT(t−1) is indicated by “ARa(t−1),” and a human position assumption region corresponding to the tracking frame WT(t) is indicated by “ARa(t).” Further, a position at which a human is detected in the human position assumption region ARa(t−2) is indicated by DH(t−2). In addition, a position at which a human is detected in the human position assumption region ARa(t−1) is indicated by HD(t−1) and a position at which a human is detected in the human position assumption region ARa(t) is indicated by DH(t).

The human detection reliability calculation unit 441 calculates human detection reliability RD using the tracking result and the human detection result for each piece of tracking identification information. For example, in the case illustrated in (a) of FIG. 7, a human is detected in the human position assumption region corresponding to the tracking frame WT in each of the frames at times T−2, t−1, and t. Accordingly, the human detection reliability RD is “(the number of frames in which a human is detected/the number of frame in which tracking is performed)=(3/3).” In addition, in the case illustrated in (b) of FIG. 7, a human is detected only in the frame at time t−2. Therefore, the human detection reliability RD is “(the number of frames in which a human is detected/the number of frame in which tracking is performed)=(1/3).” The human detection reliability calculation unit 441 outputs the human detection reliability RD calculated for each piece of tracking identification information to the counting unit 451.

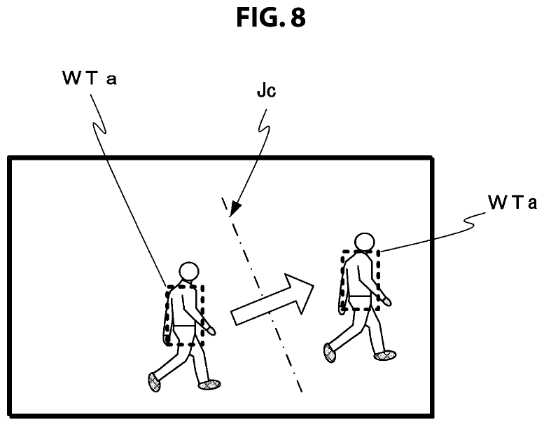

The counting unit 451 determines a tracking frame passing a counting line which is a determination position on the basis of the tracking result supplied from the tracking unit 422. In addition, the counting unit 451 compares the human detection reliability corresponding to each tracking frame passing the counting line with a preset counting target determination threshold using the human detection reliability supplied from the human detection reliability calculation unit 441. Further, the counting unit 451 sets humans corresponding to the tracking frame in which the human detection reliability is equal to or greater than the counting target determination threshold as counting targets and performs human counting. FIG. 8 exemplifies an operation of the counting unit. For example, in a case in which a tracking frame WTa crosses a counting line Jc set in advance by a user or the like and moves, the human detection reliability RD corresponding to the tracking frame WTa crossing the counting line Jc is compared with the counting target determination threshold. Here, in a case in which the human detection reliability RD is equal to or greater than the counting target determination threshold, subjects corresponding to the tracking frame WTa are set as counting target humans on the assumption that humans are correctly detected in a human detection result. In addition, in a case in which the human detection reliability RD is less than the counting target determination threshold, a human is assumed not to be correctly detected and a subject corresponding to the tracking frame in the human detection result corresponding to the tracking frame, and thus the subject corresponding to the tracking frame is not counted. The counting unit 451 outputs the counting result to the output unit 461.

In addition, the output unit 461 causes the display device 50 to display the captured image generated by the imaging device 20. In addition, the output unit 461 supplies information indicating the crowded region and the uncrowded region, for example, from the threshold map generation unit 412 to the output unit 461 to identify the partitioned regions in response to a user manipulation and display the crowded region and the uncrowded region in the captured image so that the crowded region and the uncrowded region in the captured image can be identified. In addition, the output unit 461 superimposes, for example, an image indicating the position of the counting line on the captured image for display so that the position of the counting line can be identified. Further, the output unit 461 causes the display device 50 to display the information acquired by the image processing device 40, for example, a counting result of the counting unit 451. Note that, for example, when the counting result is displayed along with the captured image and the counting line, the image of the human passing the counting line and the counting result calculated from the captured image are displayed so that the user can ascertain a progress situation or the like of the counting.

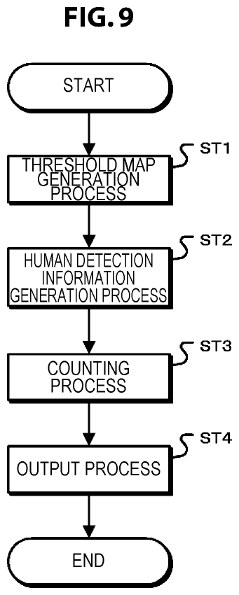

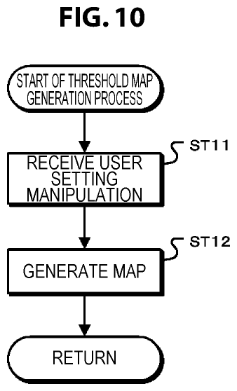

FIG. 9 is a flowchart illustrating an operation according to the first embodiment. In step ST1, the image processing device 40 performs a threshold map generation process. FIG. 10 is a flowchart illustrating the threshold map generation process. In step ST11, the image processing device 40 receives a user setting manipulation. The threshold map generation unit 412 of the image processing device 40 receives a manipulation signal supplied from the input device 30, and then the process proceeds to step ST12.

In step ST12, the image processing device 40 generates a map. The threshold map generation unit 412 of the image processing device 40 partitions the captured image generated by the imaging device 20 into the crowded region ARc and the uncrowded region ARs in response to a user manipulation. In addition, the threshold map generation unit 412 acquires the human determination threshold in accordance with the level of crowdedness set by the user from the threshold storage unit 411 and sets the human determination threshold in each of the crowded region ARc and the uncrowded region ARs. The threshold map generation unit 412 generates a threshold map indicating the crowded region Arc, the uncrowded region ARs, and the human determination threshold of each of the regions.

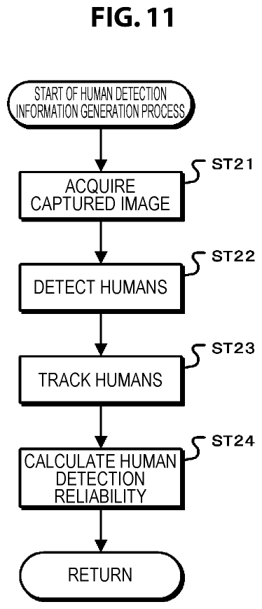

Referring back to FIG. 9, in step ST2, the image processing device 40 performs a human detection information generation process. FIG. 11 is a flowchart illustrating the human detection information generation process. In step ST21, the image processing device 40 acquires the captured image. The human detection unit 421 of the image processing device 40 acquires the captured image generated by the imaging device 20, and then the process proceeds to step ST22.

In step ST22, the image processing device 40 detects humans. The human detection unit 421 of the image processing device 40 calculates scores indicating likelihood of the humans on the basis of a feature amount or the like using the captured image generated by the imaging device 20. In addition, the human detection unit 421 compares the human determination threshold corresponding to the region with the scores of subjects inside the region for each region shown in the threshold map to determine that the subjects with the scores equal to or greater than the human determination threshold are the human. The human detection unit 421 sets the human detection position which is the position of the subject determined to be the human as the human detection result, and then the process proceeds to step ST23.

In step ST23, the image processing device 40 performs human tracking. The tracking unit 422 of the image processing device 40 sets a tracking frame on the basis of the human detection result and predicts a position of the tracking frame in a subsequently acquired captured image from the image within the set tracking frame and the subsequently acquired captured image. In addition, the tracking unit 422 sets the tracking identification information at the time of the setting of the tracking frame. Further, the tracking unit 422 includes the tracking identification information set in the tracking frame in information indicating the predicted position of the tracking frame as the tracking result, and then the process proceeds to step ST24.

In step ST24, the image processing device 40 calculates the human detection reliability. The human detection reliability calculation unit 441 of the image processing device 40 calculates the human detection reliability indicating a situation of the human detection corresponding to the tracking frame at the predicted position on the basis of the human detection result obtained in step ST22 and the tracking result obtained in step ST23. The human detection reliability calculation unit 441 sets the human detection reliability to be high in a case in which a ratio at which the humans are detected to correspond to the tracking frame at the predicted position is large, and sets the human detection reliability to be low in a case in which the ratio at which the humans are detected is small. The human detection reliability calculation unit 441 sets the position of the tracking frame and the human detection reliability of each tracking frame as human detection information.

Referring back to FIG. 9, in step ST3, the image processing device 40 performs the counting process. The counting unit 451 of the image processing device 40 determines the tracking frame passing the counting line using the human detection information generated in step ST2. The subjects of the tracking frame in which the human detection reliability corresponding to the determined tracking frame is equal to or greater than the preset counting target determination threshold are further counted as the counting targets, the number of humans passing the counting line is calculated, and then the process proceeds to step ST4.

In step ST4, the image processing device 40 performs an output process. The output unit 461 of the image processing device 40 displays the counting process result obtained in step ST3. The output unit 461 superimposes, for example, the image indicating the position of the counting line and an image indicating the counting result of the humans passing the counting line on the captured image for display.

According to the first embodiment, the human detection can be performed with high precision in the crowded region. In addition, since the human detection reliability is calculated, the human detection information with high reliability and high precision can be obtained. In addition, since the human detection can be performed with high precision even in the crowded region, the human detection information can be used to calculate the number of humans in the crowded region with high precision.

### 3. Second Embodiment

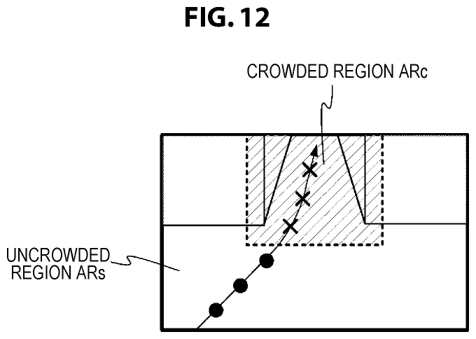

Next, a second embodiment will be described. It is more difficult to detect humans in a crowded region than in an uncrowded region due to an increase in approach, overlapping, or the like of the humans. Accordingly, for example, as illustrated in FIG. 12, in a case in which a human is moving from an uncrowded region to a crowded region, there is a concern that the human detected through the human detection at the position of the uncrowded region are not detected at the position of the crowded region. Note that the human is moving in a direction indicated by an arrow in FIG. 12, black circle marks exemplify positions at which the human is detected, and X marks exemplify positions at which the human is not detected.

Accordingly, when a counting line is set in the crowded region, a case in which a human passing the counting line is not counted occurs in some cases even when the human detected at the position of the uncrowded region has passed the counting line. In these cases, the number of humans passing the counting line may not be measured with high precision. Accordingly, in the second embodiment, when humans detected in an uncrowded region are tracked and have moved from the uncrowded region to a crowded region, the humans are set to be detected even in the crowded region. Specifically, in a case in which the position of a tracking frame is predicted through the tracking as in the first embodiment, there is a high possibility of humans being located in a human position assumption region corresponding to the tracking frame at a predicted position. Therefore, in the human position assumption region, a human determination threshold is adjusted so that it is easy to detect humans.

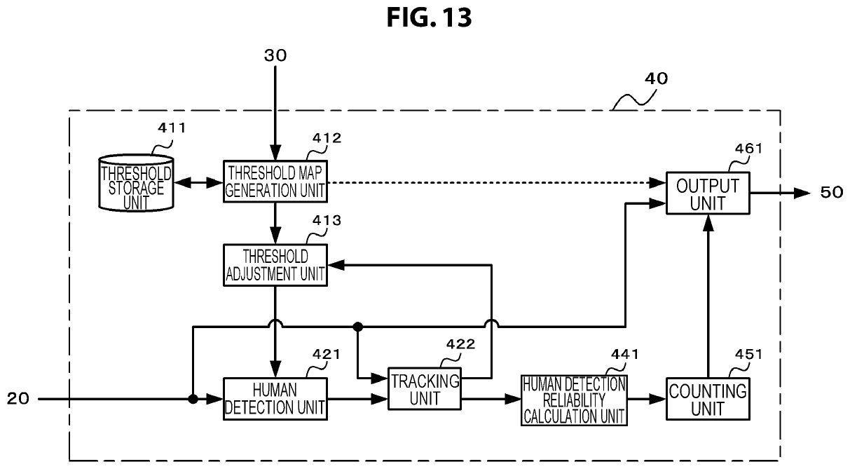

FIG. 13 is a diagram illustrating a configuration according to the second embodiment of the image processing device according to the present technology. An image processing device 40 includes a threshold storage unit 411, a threshold map generation unit 412, a threshold adjustment unit 413, a human detection unit 421, a tracking unit 422, a human detection reliability calculation unit 441, a counting unit 451, and an output unit 461.

The threshold storage unit 411 stores a human determination threshold at each level of crowdedness in advance. The threshold storage unit 411 outputs a human determination threshold in accordance with a level of crowdedness indicated in the threshold map generation unit 412 to the threshold map generation unit 412.

The threshold map generation unit 412 generates a threshold map in response to a user manipulation on the basis of a manipulation signal supplied from an input device 30. The threshold map generation unit 412 partitions a captured image generated by an imaging device 20 into a plurality of regions with different levels of crowdedness in response to a user manipulation. In addition, the threshold map generation unit 412 acquires the human determination threshold from the threshold storage unit 411 in response to a level of crowdedness designation manipulation on the partitioned regions by the user. The threshold map generation unit 412 generates, for example, a threshold map indicating a crowded region, an uncrowded region, and a human determination threshold for each region by causing the acquired human determination threshold to correspond to the partitioned region and outputs the threshold map to the threshold adjustment unit 413.

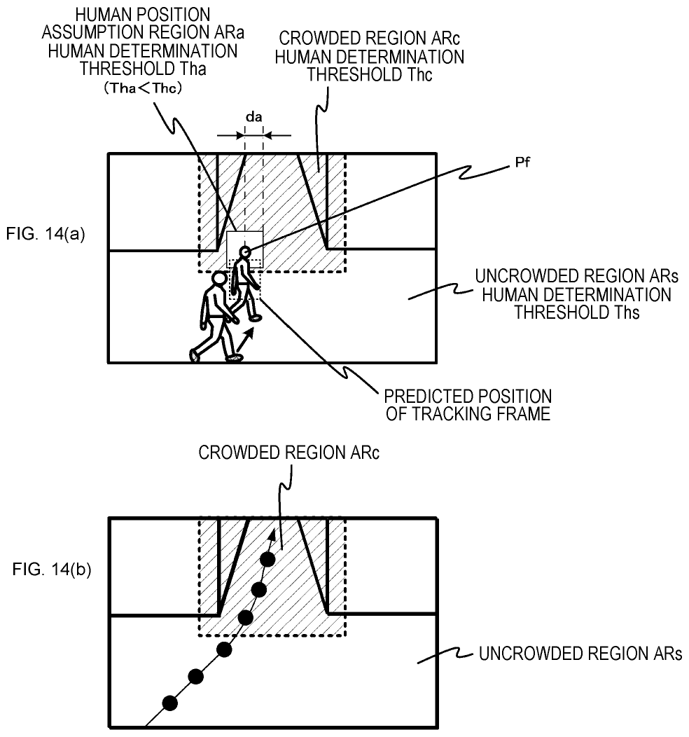

The threshold adjustment unit 413 performs threshold adjustment on the threshold map generated by the threshold map generation unit 412 on the basis of a tracking result supplied from the tracking unit 422 to be described below. The threshold adjustment unit 413 adjusts the human determination threshold of the human position assumption region with regard to the tracking frame at the predicted position indicated in the tracking result so that it is easy to determine the humans and outputs the threshold map after the adjustment of the threshold to the human detection unit 421. FIG. 14 is an explanatory diagram illustrating an operation of adjusting the human determination threshold. The threshold adjustment unit 413 adjusts the human determination threshold of the human position assumption region corresponding to the tracking frame at the predicted position so that it is easier to determine the humans than before the adjustment since the predicted position of the tracking frame at the time of subsequent human detection is indicated in the tracking result. As illustrated in (a) of FIG. 14, the threshold adjustment unit 413 sets, for example, a position Pf of a head assumed from the predicted position of the tracking frame as a reference and sets a human position assumption region ARa as a range of each width da in the horizontal and vertical directions from the position Pf. In addition, the threshold adjustment unit 413 sets a human determination threshold of the human position assumption region ARa as a human determination threshold Tha (<Thc) less than the human determination threshold Thc before the adjustment, and thus it is also easy to detect the humans in the human position assumption region ARa. The human determination threshold Tha may be a value that decreases by a predetermined reduction amount from the human determination threshold Thc or a value obtained by decreasing the human determination threshold THc at a predetermined ratio may be used. In addition, the decrease amount or the reduction ratio may be set in accordance with the level of crowdedness. Further, in a case in which no human is detected in the human position assumption region ARa corresponding to the tracking frame at the predicted position, a user may set the human determination threshold Tha so that humans are detected in the human position assumption region ARa and the threshold adjustment unit 413 may use the set human determination threshold Tha through subsequent human detection.

The human detection unit 421 performs the human detection using a captured image generated by the imaging device 20. In the human detection, a score indicating likelihood of humans is calculated. In addition, the human detection unit 421 compares the human determination threshold corresponding to a region with the score of the subject inside the region for each region indicated by the threshold map adjusted by the threshold adjustment unit 413 and determines that a subject with the score equal to or greater than the human determination threshold is a human. Here, since the human determination threshold is adjusted so that it is easy to determine a human in the human position assumption region, as illustrated in (b) of FIG. 14, a human moving from the uncrowded region to the crowded region can be detected even in the crowded region ARc. The human detection unit 421 includes the tracking identification information in information regarding the human detection position indicating the position of the subject determined to be the human to output the tracking identification information as a human detection result to the tracking unit 422.

The tracking unit 422 performs tracking of humans detected on the basis of the human detection result supplied from the human detection unit 421 and includes the tracking identification information allocated to the tracking frame in information indicating the predicted position of the tracking frame to output the tracking identification information as a tracking result to the threshold adjustment unit 413. In addition, the tracking unit 422 outputs the tracking result and the human detection result to the human detection reliability calculation unit 441.

The human detection reliability calculation unit 441 calculates the human detection reliability using the tracking result and the human detection result. The human detection reliability calculation unit 441 retains a history of the human detection result corresponding to the tracking frame for each piece of tracking identification information. In addition, the human detection reliability calculation unit 441 calculates a detection situation of the human detection corresponding to a position tracked on the basis of the tracked position and the human detection result using the retained history for each piece of tracking identification information and sets the detection situation as the human detection reliability. The human detection reliability calculation unit 441 outputs the human detection reliability calculated for each piece of tracking identification information to the counting unit 451.

The counting unit 451 determines the tracking frame passing the counting line which is a determination position on the basis of the tracking result supplied from the tracking unit 422. In addition, the counting unit 451 compares the human detection reliability corresponding to each tracking frame passing the counting line with the preset counting target determination threshold using the human detection reliability supplied from the human detection reliability calculation unit 441. Further, the counting unit 451 sets humans corresponding to the tracking frame in which the human detection reliability is equal to or greater than the counting target determination threshold as counting targets and performs human counting. The counting unit 451 outputs a human counting result to the output unit 461.

The output unit 461 causes the display device 50 to display the captured image generated by the imaging device 20. In addition, the output unit 461 causes the display device 50 to display the position of the counting line and the regions partitioned in response to a user manipulation so that the position of the counting lines or the regions can be identified. Further, the output unit 461 causes the display device 50 to display information regarding the result or the like acquired by the image processing device 40.

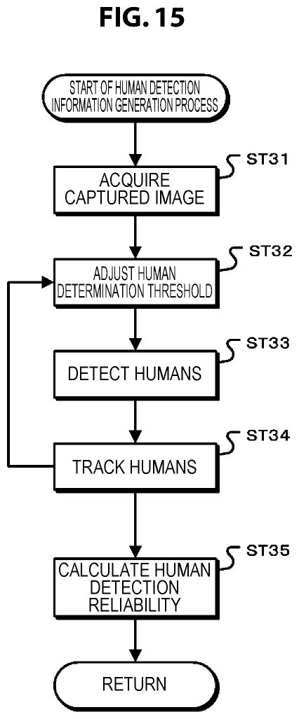

In the second embodiment, the process of the flowchart illustrated in FIG. 9 is performed. In the human detection information generation process of step ST2, a process of the flowchart illustrated in FIG. 15 is performed unlike the first embodiment.

In step ST31 of FIG. 15, the image processing device 40 acquires a captured image. The human detection unit 421 of the image processing device 40 acquires the captured image generated by the imaging device 20, and then the process proceeds to step ST32.

In step ST32, the image processing device 40 adjusts the human determination threshold. The threshold adjustment unit 413 of the image processing device 40 adjusts the human determination threshold of the human position assumption region corresponding to the tracking frame at the predicted position in the threshold map so that it is easy to determine the humans, and then the process proceeds to step ST33.

In step ST33, the image processing device 40 performs the human tracking. The human detection unit 421 of the image processing device 40 calculates scores indicating likelihood of the humans on the basis of a feature amount or the like using the captured image generated by the imaging device 20. In addition, the human detection unit 421 compares the human determination threshold with the scores of subjects inside the region for each region using the threshold map in which the human determination threshold is adjusted in step ST32 and determines the subject with the score equal to or greater than the human determination threshold as the human. The human detection unit 421 sets the human detection position which is the position of the subject determined to be the human as the human detection result, and then the process proceeds to step ST34.

In step ST34, the image processing device 40 performs human tracking. The tracking unit 422 of the image processing device 40 sets a tracking frame on the basis of the human detection result and predicts a position of the tracking frame in a subsequently acquired captured image from the image within the set tracking frame and the subsequently acquired captured image. In addition, the tracking unit 422 sets the tracking identification information at the time of the setting of the tracking frame. Further, the tracking unit 422 includes the tracking identification information set in the tracking frame in information indicating the predicted position of the tracking frame as the tracking result. In addition, the tracking unit 422 outputs the tracking result to the threshold adjustment unit 413 to adjust the human determination threshold, as described above, in subsequent human detection, and then the process proceeds to step ST35.

In step ST35, the image processing device 40 calculates the human detection reliability. The human detection reliability calculation unit 441 of the image processing device 40 calculates the human detection reliability indicating a situation of the human detection corresponding to the tracking frame at the predicted position on the basis of the human detection result obtained in step ST33 and the tracking result obtained in step ST34. The human detection reliability calculation unit 441 sets the position of the tracking frame and the human detection reliability of each tracking frame as human detection information.

According to the second embodiment, the human detection information with high reliability and high precision can be obtained as in the first embodiment. Further, in the second embodiment, since the human determination threshold in the region within the predetermined range set using the predicted position of the tracking frame as the reference is adjusted so that it is easy to determine the humans, it is possible to prevent deterioration in detection precision of the human detection. Accordingly, it is possible to prevent, for example, a human detected through the human detection at the position of the uncrowded region from not being detected at the position crowded region.

### 4. Third Embodiment

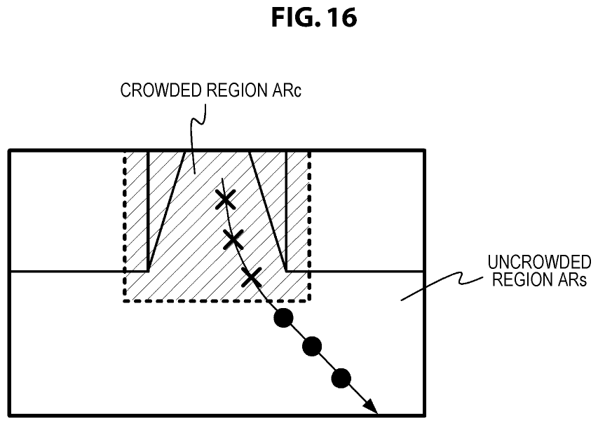

Next, a third embodiment will be described. As described above, it is more difficult to detect humans in a crowded region than in an uncrowded region due to an increase in approach, overlapping, or the like of the humans. Accordingly, for example, as illustrated in FIG. 16, in a case in which a human is moving from a crowded region to an uncrowded region, there is a concern that the human detected through the human detection at the position of the uncrowded region are not detected at the position of the crowded region. Note that the human is moving in a direction indicated by an arrow in FIG. 16, circle marks exemplify positions at which the human is detected, and X marks exemplify positions at which the human is not detected.

Accordingly, for example, when a counting line is set in the crowded region, there is a concern that a human detected through the human detection at the position of the uncrowded region is not detected through the human detection at the position of the crowded region and is not counted as a human passing the counting line. Therefore, the number of humans passing the counting line may not be measured with high precision. Accordingly, in the third embodiment, a human detected in the uncrowded region is tracked in the past direction. The human can be detected with high precision even in the crowded region when the human has moved from the uncrowded region to the crowded region. Specifically, the tracking is performed in the past direction which is reverse to the time direction of the second embodiment. In addition, since there is a high possibility of a human being located in a region with a predetermined region set using the predicted position of the tracking frame as a reference, the human determination threshold is adjusted so that it is easy to detect the human in a region in which there is the high possibility of the human being located.

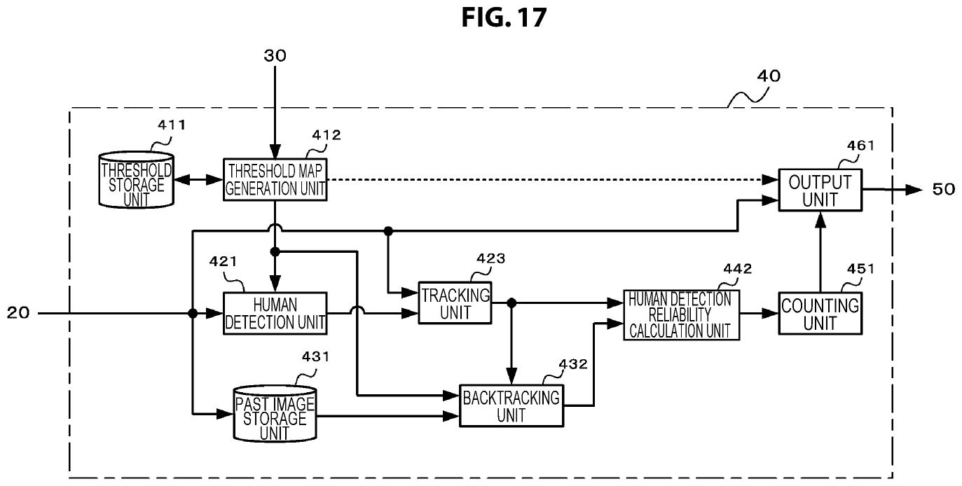

FIG. 17 is a diagram illustrating a configuration according to a third embodiment of the image processing device according to the present technology. The image processing device 40 includes a threshold storage unit 411, a threshold map generation unit 412, a human detection unit 421, a tracking unit 423, a past image storage unit 431, a backtracking unit 432, a human detection reliability calculation unit 442, a counting unit 451, and an output unit 461.

The threshold storage unit 411 stores a human determination threshold at each level of crowdedness in advance. The threshold storage unit 411 outputs a human determination threshold in accordance with a level of crowdedness indicated in the threshold map generation unit 412 to the threshold map generation unit 412.

The threshold map generation unit 412 generates a threshold map in response to a user manipulation on the basis of a manipulation signal supplied from an input device 30. The threshold map generation unit 412 partitions a captured image generated by an imaging device 20 into a plurality of regions with different levels of crowdedness in response to a user manipulation. In addition, the threshold map generation unit 412 acquires the human determination threshold from the threshold storage unit 411 in response to a level of crowdedness designation manipulation on the partitioned regions by the user. The threshold map generation unit 412 generates a threshold map indicating a crowded region, an uncrowded region, and a human determination threshold for each region by causing the acquired human determination threshold to correspond to the partitioned region and outputs the threshold map to the human detection unit 421 and the backtracking unit 432.

The human detection unit 421 performs the human detection using a captured image generated by the imaging device 20. In the human detection, a score indicating likelihood of humans is calculated. In addition, the human detection unit 421 compares the human determination threshold corresponding to a region with the score of the subject inside the region for each region indicated by the threshold map adjusted by the threshold adjustment unit 413 and determines that a subject with the score equal to or greater than the human determination threshold is a human. The human detection unit 421 outputs the human detection position indicating the position of the subject determined to be the human as a human detection result to the tracking unit 423.

The tracking unit 423 performs tracking of humans detected on the basis of the human detection result supplied from the human detection unit 421 and includes the tracking identification information set in the tracking frame in information indicating the predicted position of the tracking frame to output the tracking identification information as a tracking result to the human detection reliability calculation unit 442. In addition, in a case in which the tracking is performed in the past direction, the human determination threshold is adjusted, and the human detection is performed, the tracking unit 423 outputs a tracking result to the backtracking unit 432 and the backtracking unit 432 performs tracking in the past direction and adjusts the human determination position so that the human detection can be performed. For example, in a case in which new human detection is performed and a tracking frame is set, the tracking unit 423 assumes that the tracking is performed in the past direction and includes the tracking identification information in information indicating the position of the set tracking frame to output the tracking identification information to the backtracking unit 432. In addition, in a case in which no human is detected in the human position assumption region corresponding to the tracking frame and a human is detected at the predicted position later, the tracking unit 423 may assume that the tacking is performed in the past direction and outputs a tracking result at the time of detection of the human to the backtracking unit 432.

The past image storage unit 431 stores captured images generated by the imaging device 20, for example, until a predetermined past period from the present. In addition, the past image storage unit 431 outputs the stored captured images to the backtracking unit 432.

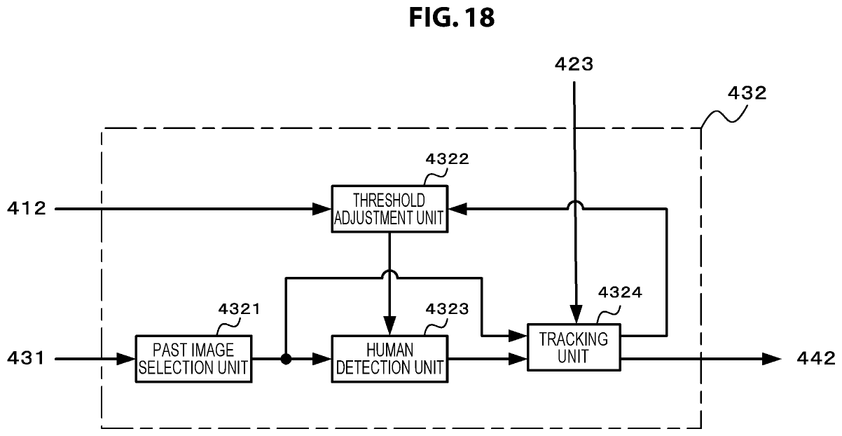

The backtracking unit 432 tracks the human of the tracking frame for each piece of tracking identification information in the past direction using the present captured image and the past captured image stored in the past image storage unit 431 on the basis of the tracking result supplied from the tracking unit 432. In addition, the backtracking unit 432 adjusts the human determination threshold of the human position assumption region corresponding to the predicted position of the tracking frame in the tracking of the past direction so that it is easy to determine the human and acquires the human detection result in the past image using the adjusted threshold map. FIG. 18 is a diagram illustrating a configuration of the backtracking unit. The backtracking unit 432 includes a past image selection unit 4321, a threshold adjustment unit 4322, a human detection unit 4323, and a tracking unit 4324.

The past image selection unit 4321 acquires the past image for predicting a tracking position from the past image storage unit 431 and outputs the past image to the human detection unit 4323 and the tracking unit 4324. For example, in a case in which the tracking position at time (t−1) is predicted with regard to the tracking frame at time t, a captured image at time (t−1) is acquired from the past image storage unit 431. In addition, in a case in which the tracking position at time (t−2) is predicted with regard to the tracking frame at time (t−1), a captured image at time (t−2) is acquired from the past image storage unit 431.

The threshold adjustment unit 4322 performs threshold adjustment on the threshold map generated by the threshold map generation unit 412 on the basis of the tracking result supplied from the tracking unit 4324. The threshold adjustment unit 4322 adjusts the human determination threshold of the human position assumption region corresponding to the tracking frame at the predicted position indicated in the tracking result so that it is easy to determine the human and outputs the threshold map subjected to the threshold adjustment to the human detection unit 4323.

The human detection unit 4323 performs the human detection using the past image acquired by the past image selection unit 4321. In the human detection, a score indicating likelihood of humans is calculated. In addition, the human detection unit 4323 compares the human determination threshold corresponding to a region with the score of the subject inside the region for each region indicated by the threshold map adjusted by the threshold adjustment unit 4322 and determines that a subject with the score equal to or greater than the human determination threshold is a human. The human detection unit 4323 outputs the human detection position indicating the position of the subject determined to be the human as a human detection result to the tracking unit 4324.

The tracking unit 4324 tracks the tracking frame indicated in the tracking unit 423 in the past direction for each piece of tracking identification information. For example, when a tracking result is supplied from the tracking unit 423, the tracking unit 4324 starts tracking the human shown in the tracking frame of the tracking identification information indicated in the tracking result in the past direction. The tracking unit 4324 tracks the tracking frame in the past direction using an image which is the past image acquired by the past image selection unit 4321 and which is an image older than the captured image and is used at the time of generation of the tracking result supplied from the tracking unit 423. The tracking unit 4324 performs the tracking in the past direction and includes the tracking identification information set in the tracking frame in the information indicating the predicted position of the tracking frame to output the tracking identification information as a tracking result to the threshold adjustment unit 4322. In addition, the tracking unit 4324 outputs the tracking result and the human detection result to the human detection reliability calculation unit 442 for each piece of tracking identification information.

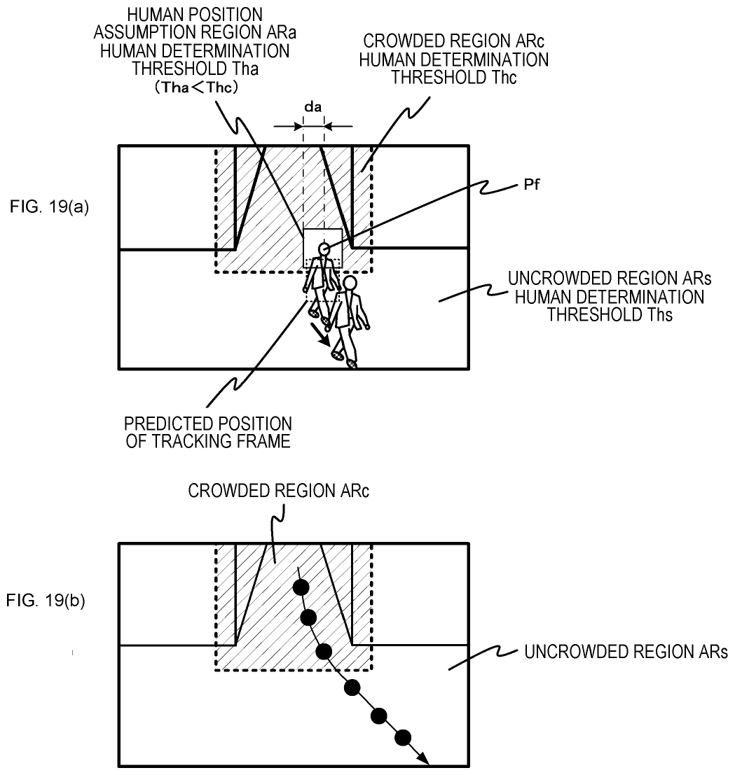

In this way, the backtracking unit 432 tracks the tracking frame set by the tracking unit 423 in the past direction for each piece of tracking identification information, adjusts the human determination threshold of the human position assumption region corresponding to the tracking frame at the predicted position so that it is easy to determine the human, and performs the human detection. That is, the operation described with reference to FIG. 14 in the second embodiment is performed in a reverse direction to the time direction, the human is tracked retrospectively at the position of the uncrowded region, and the human determination threshold is adjusted so that the human is also detected even in the crowded region. Accordingly, as illustrated in (a) of FIG. 19, the position Pf of a head assumed from the predicted position of the tracking frame predicted in the past direction is set as a reference and a human position assumption region ARa is set as a range of each width da in the horizontal and vertical directions from the position Pf. In addition, the threshold adjustment unit 4322 sets a human determination threshold of the human position assumption region ARa as a human determination threshold Tha (<Thc) less than the human determination threshold Thc before the adjustment, and thus it is also easy to detect the humans in the human position assumption region ARa. Therefore, as illustrated in (b) of FIG. 19, the human moving from the crowded region to the uncrowded region can be detected retrospectively in the past direction even in the crowded region ARc.

Note that the humans passing the counting line are counted and the humans who have passed the counting line are detected in the image processing device 40, the backtracking unit 432 sets a tracking period so that the tracking frame passes the counting line at the time of the tracking in the past direction. The tracking period is set in advance in accordance with, for example, a movement speed or the like of the humans. In addition, the tracking period may be set on the basis of the human detection result of the human detection unit 421 and the tracking result of the tracking unit 422. For example, it is possible to estimate the movement direction or the movement speed of the humans using the tracking frame at the time of the detection of the humans. In addition, a distance to the counting line can be calculated on the basis of the position of the tracking frame. Accordingly, it is possible to set the tracking period so that the tracking frame passes the counting line on the basis of the estimated movement direction or movement speed of the human and the calculated distance to the counting line.

The human detection reliability calculation unit 442 calculates the human detection reliability using the tracking result and the human detection result. The human detection reliability calculation unit 442 calculates the human detection reliability for each piece of tracking identification information on the basis of the tracking result and the human detection result in the past direction. The human detection reliability calculation unit 442 outputs the human detection reliability calculated for each piece of tracking identification information to the counting unit 451.

The counting unit 451 determines the tracking frame passing the counting line which is a determination position on the basis of the tracking result supplied from the tracking unit 423. In addition, the counting unit 451 compares the human detection reliability corresponding to each tracking frame passing the counting line with the preset counting target determination threshold using the human detection reliability supplied from the human detection reliability calculation unit 442. Further, the counting unit 451 sets humans corresponding to the tracking frame in which the human detection reliability is equal to or greater than the counting target determination threshold as counting targets and performs human counting. The counting unit 451 outputs a human counting result to the output unit 461.

The output unit 461 causes the display device 50 to display the captured image generated by the imaging device 20. In addition, the output unit 461 causes the display device 50 to display the position of the counting line and the regions partitioned in response to a user manipulation so that the position of the counting lines or the regions can be identified. Further, the output unit 461 causes the display device 50 to display information regarding the result or the like acquired by the image processing device 40.

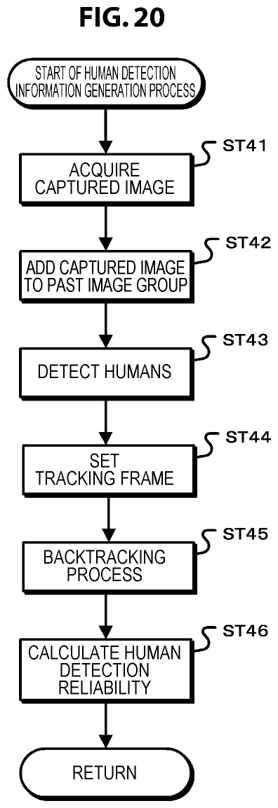

In the third embodiment, the process of the flowchart illustrated in FIG. 9 is performed. In the human detection information generation process of step ST2, a process of the flowchart illustrated in FIG. 20 is performed unlike the first embodiment.

In step ST41 of FIG. 20, the image processing device 40 acquires a captured image. The human detection unit 421 of the image processing device 40 acquires the captured image generated by the imaging device 20, and then the process proceeds to step ST42.

In step ST42, the image processing device 40 adds the acquired captured images to a past image group. The past image storage unit 431 of the image processing device 40 stores the acquired captured images in sequence, sequentially deletes the captured images from the oldest captured image, and stores the captured images until a predetermined past period from the present as a past image group, and then the process proceeds to step ST43.

In step ST43, the image processing device 40 performs the human detection. The human detection unit 421 of the image processing device 40 calculates scores indicating likelihood of the humans on the basis of a feature amount or the like using the captured image generated by the imaging device 20. In addition, the human detection unit 421 compares the human determination threshold corresponding to the region with the scores of subjects inside the region for each region indicated in the threshold map and determines the subjects with the scores equal to or greater than the human determination threshold as the humans. The human detection unit 421 sets the human detection position which is the position of the subject determined to be the human as the human detection result, and then the process proceeds to step ST44.

In step ST44, the image processing device 40 performs the human tracking. The tracking unit 423 of the image processing device 40 sets a tracking frame on the basis of the human detection result and predicts a position of the tracking frame in a subsequently acquired captured image from the image within the set tracking frame and the subsequently acquired captured image. In addition, the tracking unit 423 sets the tracking identification information at the time of the setting of the tracking frame. Further, the tracking unit 423 includes the tracking identification information set in the tracking frame in information indicating the predicted position of the tracking frame as the tracking result. Further, in a case in which the tracking in the past direction is performed, the tracking unit 423 uses the tracking result in a backtracking process, and then the process proceeds to step ST45.

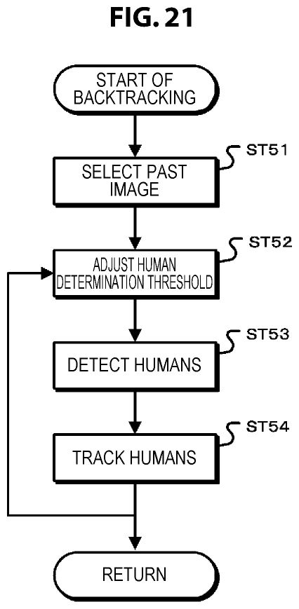

In step ST45, the image processing device 40 performs a backtracking process. FIG. 21 is a flowchart illustrating the backtracking process. In step ST51, the backtracking unit 432 selects a past image. The past image selection unit 4321 of the backtracking unit 432 acquires a past image with which the position of the tracking frame is predicted from the past image storage unit 431, and then the process proceeds to step ST52.

In step ST52, the backtracking unit 432 adjusts the human determination threshold. The threshold adjustment unit 4322 of the backtracking unit 432 adjusts the human determination threshold of the human position assumption region corresponding to the tracking frame at the predicted position in the past image older than the captured image with which the human detection is performed in the threshold map so that it is easy to determine the human, and then the process proceeds to step ST53.

In step ST53, the backtracking unit 432 performs the human detection. The human detection unit 4323 of the backtracking unit 432 calculates the scores likelihood of the humans on the basis of a feature amount or the like using the past image acquired in step ST51. In addition, the human detection unit 4323 compares the human determination threshold corresponding to the region with the scores of subjects within the region for each region shown in the threshold map and determines the subjects with the scores equal to or greater than the human determination threshold as the humans. The human detection unit 4323 sets the human detection position which is the position of the subject determined to be the human as the human detection result, and then the process proceeds to step ST54.

In step ST54, the backtracking unit 432 performs human tracking. The tracking unit 4324 of the backtracking unit 432 predicts the position of the tracking frame in the acquired past image from the image within the tracking frame set by the tracking unit 423 and the acquired past image. Further, the tracking unit 4324 includes the tracking identification information set in the tracking frame in information indicating the predicted position of the tracking frame as the tracking result. In addition, the tracking unit 4324 outputs the tracking result to the threshold adjustment unit 4322 to adjust the human determination threshold, as described above, in subsequent human detection. In addition, the backtracking unit 432 outputs the tracking result and the human detection result to the human detection reliability calculation unit 442 for each piece of tracking identification information.

Referring back to FIG. 20, in step ST46, the image processing device 40 calculates the human detection reliability. The human detection reliability calculation unit 442 of the image processing device 40 calculates the human detection reliability on the basis of the human detection result obtained through the human detection in step ST43, the setting of the tracking frame of step ST44, and the tracking result and the human detection result obtained in the backtracking process of step ST45. The human detection reliability calculation unit 441 sets the position of the tracking frame and the human detection reliability of each tracking frame as human detection information.

According to the third embodiment, the human detection information with high reliability and high precision can be obtained as in the first embodiment. Further, in the third embodiment, since the human determination threshold in the region within the predetermined range set using the position of the tracking frame predicted in the past direction as the reference is adjusted so that it is easy to determine the humans, it is possible to prevent deterioration in detection precision of the human detection. Accordingly, in a case in which, for example, the human moving from the crowded region to the uncrowded region is detected in the uncrowded region, the human can be detected even in the crowded region through the backtracking process.

### 5. Fourth Embodiment

In a fourth embodiment, a case in which a function of generating threshold information stored in a threshold storage unit 411 is provided will be exemplified.

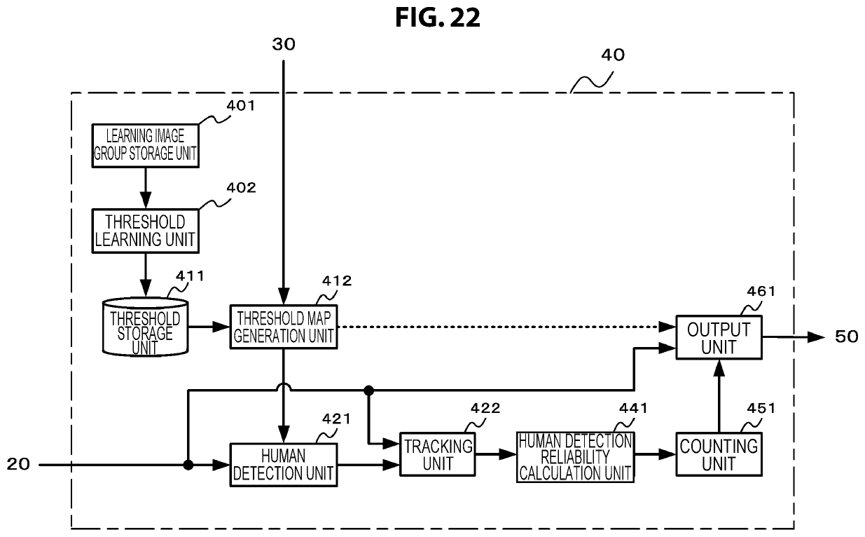

FIG. 22 is a diagram illustrating a configuration of the fourth embodiment of an image processing device according to the present technology. An image processing device 40 includes a learning image group storage unit 401, a threshold learning unit 402, a threshold storage unit 411, a threshold map generation unit 412, a human detection unit 421, a tracking unit 422, a human detection reliability calculation unit 441, a counting unit 451, and an output unit 461.

The learning image group storage unit 401 stores a learning image group for determining a human determination threshold suitable for a crowded situation by learning. The learning image group storage unit 401 stores, for example, a crowded image group and an uncrowded image group as a learning image group. The crowded image group is an image group in which humans are crowded. The image group is formed by one image or a plurality of images at each level of crowdedness. The uncrowded image group is an image group in a state in which the humans are disperse.

The threshold learning unit 402 sets a human determination threshold corresponding to the crowded region and a human determination threshold corresponding to the uncrowded region using the learning image. In addition, the threshold learning unit 402 sets the human determination threshold at each level of crowdedness using the learning image.

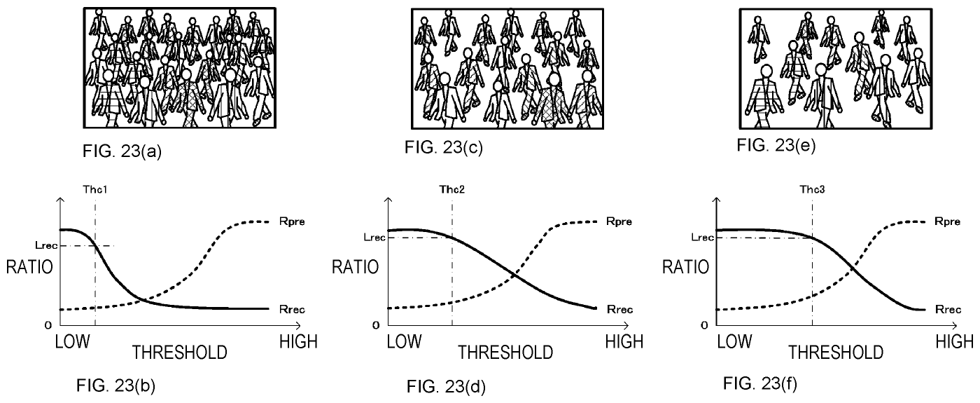

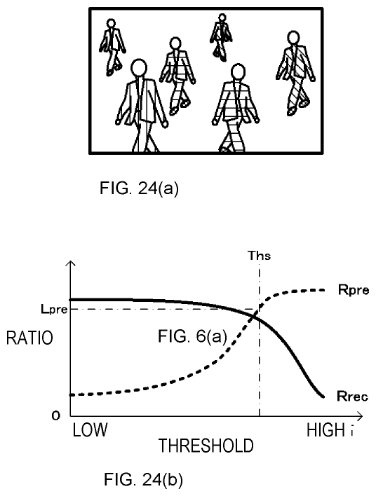

FIGS. 23 and 24 are explanatory diagrams illustrating a learning method for a human determination threshold performed by the threshold learning unit 402. (a) and (b) of FIG. 23 exemplify a learning image and a relation between a recall ratio and a precision ratio and a threshold in a case in which the level of crowdedness is high in a crowded region (level of crowdedness 1 is set). (c) and (d) of FIG. 23 exemplify a learning image and a relation between a recall ratio and a precision ratio and a threshold in a case in which the level of crowdedness is lower than in (a) of FIG. 23 in a crowded region (level of crowdedness 2 is set). (e) and (f) of FIG. 23 exemplify a learning image and a relation between a recall ratio and a precision ratio and a threshold in a case in which the level of crowdedness is lower than in (c) of FIG. 23 in a crowded region (level of crowdedness 3 is set). In addition, (a) and (b) of FIG. 24 exemplify a learning image and a relation between a recall ratio and a precision ratio and a threshold in a case in an uncrowded region.

The threshold learning unit 402 performs learning using a learning image and correct answer data of humans shown in the learning image. In learning of a crowded region, an image with each level of crowdedness at which humans in an image are evenly crowded in the image so that there is no influence of distribution of the humans in the image is used as a learning image. In addition, the threshold learning unit 402 calculates a recall ratio Rrec and a precision ratio Rpre in each image group while changing the threshold in the image with each level of crowdedness. Further, the threshold learning unit 402 sets a threshold in which the recall ratio Rrec is equal to or greater than “Lrec” and the precision ratio Rpre is highest as a human determination threshold at each level of crowdedness. For example, a human determination threshold at level of crowdedness 1 is referred to as “Thc1,” a human determination threshold at level of crowdedness 2 is referred to as “Thc2,” and a human determination threshold at level of crowdedness 3 is referred to as “Thc3.”

In learning of an uncrowded region, an image in which humans are evenly disperse in the image so that there is no influence of distribution of the humans in the image is used as a learning image. In addition, the threshold learning unit 402 calculates the recall ratio Rrec and the precision ratio Rpre while changing the threshold. Further, the threshold learning unit 402 sets a threshold in which the precision ratio Rpre is equal to or greater than “Lpre” and the recall ratio Rrec is the highest as a human determination threshold. For example, the human determination threshold of the uncrowded region is referred to as “Ths.” Note that in the uncrowded region, as illustrated in FIG. 24, both the recall ratio Rrec and the precision ratio Rpre may be set to be high.

The threshold storage unit 411 stores the learning result of the threshold learning unit 402 and outputs the human determination threshold in accordance with the level of crowdedness indicated in the threshold map generation unit 412 to the threshold map generation unit 412.

The threshold map generation unit 412 generates the threshold map in response to a user manipulation on the basis of a manipulation signal supplied from the input device 30. The threshold map generation unit 412 partitions a captured image generated by the imaging device 20 into a plurality of regions with different levels of crowdedness in response to a user manipulation. In addition, the threshold map generation unit 412 acquires the human determination threshold from the threshold storage unit 411 in response to a level of crowdedness designation manipulation on the partitioned region by the user. The threshold map generation unit 412 generates a threshold map indicating a crowded region, an uncrowded region, and a human determination threshold for each region by causing the acquired human determination threshold to correspond to the partitioned region and outputs the threshold map to the threshold adjustment unit 421.

The human detection unit 421 performs the human detection using a captured image generated by the imaging device 20. In the human detection, a score indicating likelihood of humans is calculated. In addition, the human detection unit 421 compares the human determination threshold corresponding to a region with the score of the subject inside the region for each region indicated by the threshold map and determines that a subject with the score equal to or greater than the human determination threshold is a human. The human detection unit 421 outputs a human detection position indicating the position of the subject determined to be the human as a human detection result to the tracking unit 422.

The tracking unit 422 performs tracking of humans detected on the basis of the human detection result supplied from the human detection unit 421 and includes the tracking identification information allocated to the tracking frame in information indicating the predicted position of the tracking frame to output the tracking identification information as a tracking result to the threshold adjustment unit 413. In addition, the tracking unit 422 outputs the tracking result and the human detection result to the human detection reliability calculation unit 441.

The human detection reliability calculation unit 441 calculates the human detection reliability using the tracking result and the human detection result. The human detection reliability calculation unit 441 retains a history of the human detection result corresponding to the tracking frame for each piece of tracking identification information. In addition, the human detection reliability calculation unit 441 sets the human detection reliability for each piece of tracking identification information using the retained history. The human detection reliability calculation unit 441 outputs the human detection reliability calculated for each piece of tracking identification information to the counting unit 451.

The counting unit 451 determines the tracking frame passing the counting line which is a determination position on the basis of the tracking result supplied from the tracking unit 422. In addition, the counting unit 451 compares the human detection reliability corresponding to each tracking frame passing the counting line with the preset counting target determination threshold using the human detection reliability supplied from the human detection reliability calculation unit 441. Further, the counting unit 451 sets humans corresponding to the tracking frame in which the human detection reliability is equal to or greater than the counting target determination threshold as counting targets and performs human counting. The counting unit 451 outputs a human counting result to the output unit 461.

The output unit 461 causes the display device 50 to display the captured image generated by the imaging device 20. In addition, the output unit 461 causes the display device 50 to display the position of the counting line and the regions partitioned in response to a user manipulation so that the position of the counting lines or the regions can be identified. Further, the output unit 461 causes the display device 50 to display information regarding the result or the like acquired by the image processing device 40.

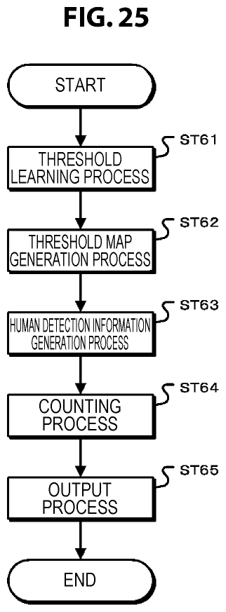

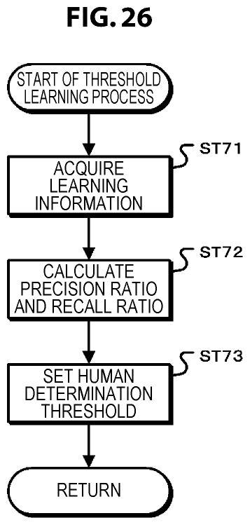

FIG. 25 is a flowchart illustrating an operation according to the fourth embodiment. In step ST61, the image processing device 40 performs the threshold learning process. FIG. 26 is a flowchart illustrating the threshold learning process.

In step ST71, the image processing device 40 acquires learning information. The threshold learning unit 402 of the image processing device 40 acquires learning images as the learning information and correct answer data of humans shown in the learning images. As the learning images, a crowded image group with each level of crowdedness in which humans are evenly crowded in the image and an uncrowded image group in which humans are evenly disperse in the images so that there is no influence of distribution of the humans in the images are used. The threshold learning unit 402 acquires the learning information, and then the process proceeds to step ST72.

In step ST72, the image processing device 40 calculates a precision ratio and a recall ratio. The threshold learning unit 402 of the image processing device 40 calculates the recall ratio Rrec and the precision ratio Rpre in each image group while changing the threshold with regard to the crowded image group and the uncrowded image group with each level of crowdedness, and then the process proceeds to step ST73.

In step ST73, the image processing device 40 sets the human determination threshold. The threshold learning unit 402 of the image processing device 40 sets the threshold in which the recall ratio Rrec is equal to or greater than “Lrec” and the precision ratio Rpre is the highest at each level of crowdedness as the human determination threshold in the crowded image group. In addition, the threshold learning unit 402 determines the threshold in which the precision ratio Rpre is equal to or greater than “Lpre” and the recall ratio Rrec is the highest as the human determination threshold in the uncrowded image group. The threshold learning unit 402 stores the human determination threshold set in each of the crowded image group and the uncrowded image group at each level of crowdedness in the threshold storage unit 411.

Referring back to FIG. 25, the image processing device 40 performs the threshold map generation process in step ST62. The threshold map generation unit 412 of the image processing device 40 performs the same process as step ST1 of FIG. 9. That is, the threshold map generation unit 412 partitions a captured image into a plurality of regions with different levels of crowdedness in response to a user manipulation. In addition, the threshold map generation unit 412 acquires the human determination threshold from the threshold storage unit 411 in response to a level of crowdedness designation manipulation on the partitioned region by the user. Further, the threshold map generation unit 412 generates the threshold map by causing the acquired human determination threshold to correspond to the partitioned region, and then the process proceeds to step ST63.

In step ST63, the image processing device 40 performs the human detection information generation process. The image processing device 40 performs the same process as step ST2 of FIG. 9. That is, the human detection unit 421 performs subject detection and generates a human detection result indicating a human detection position. In addition, the tracking unit 422 performs setting a tracking frame using the human detection result, predicts a position of the tracking frame in a subsequently acquired captured image from the image within the set tracking frame and the subsequently acquired captured image, and performs tracking of humans of the tracking frame. Further, the human detection reliability calculation unit 441 calculates the human detection reliability on the basis of the tracking result and the human detection result. The image processing device 40 sets the position of the tracking frame and the human detection reliability for each tracking frame as human detection information, and then the process proceeds to step ST64.

In step ST64, the image processing device 40 performs the counting process. The counting unit 451 of the image processing device 40 performs the same process as step ST3 of FIG. 9 and determines the tracking frame passing the counting line from the position of the tracking frame in the human detection information generated in step ST63. Further, in the determined tracking frame, humans of the tracking frame in which the human detection reliability is equal to or greater than a preset counting target determination threshold are set as counting targets and the counting is performed to calculate the number of humans passing the counting line, and then the process proceeds to step ST65.

In step ST65, the image processing device 40 performs an output process. The output unit 461 of the image processing device 40 performs the same process as step ST4 of FIG. 9 and displays a counting process result obtained in step ST64.

According to the fourth embodiment, since the human determination threshold is set by the learning using the crowded image group and the uncrowded image group, the human determination threshold optimum for a human crowded situation can be set. Accordingly, in each of the crowded region and the uncrowded region, the human detection can be performed optimally in accordance with the level of crowdedness.

### 6. Other Embodiments

In the above-described embodiments, the cases in which the threshold map is generated in response to a user manipulation or the like in accordance with the preset crowded region and uncrowded region and the level of crowdedness of the crowded region. However, the present technology is not limited to the case in which the region setting and the level of crowdedness setting are performed on the basis of the user manipulation or the like. For example, the region setting and the level of crowdedness setting may be performed automatically on the basis of a captured image to generate the threshold map. In another embodiment, a case in which the region setting and the level of crowdedness setting are performed automatically will be described.

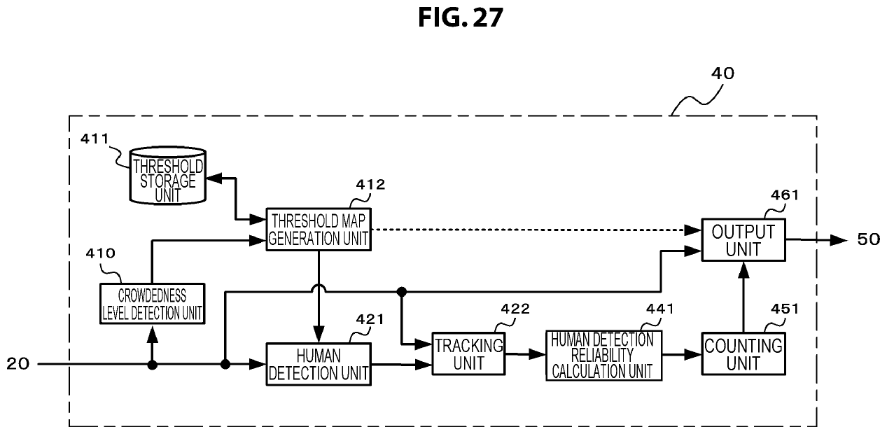

FIG. 27 is a diagram illustrating a configuration according to another embodiment. An image processing device 40 includes a crowdedness level detection unit 410, a threshold storage unit 411, a threshold map generation unit 412, a human detection unit 421, a tracking unit 422, a human detection reliability calculation unit 441, a counting unit 451, and an output unit 461.

The crowdedness level detection unit 410 detects a level of crowdedness using a captured image acquired by an imaging device 20. The crowdedness level detection unit 410 generates a dictionary indicating relevance between a density and a feature amount of humans in an image region in advance, as disclosed in, for example, the document “V. Lempisky and A. Zizzerman, “Learning to count objects in images”, in Neural Information Processing Systems, (2010)” and predicts a level of crowdedness of the humans from a feature amount extraction result of an image in detection of the level of crowdedness. In addition, in the detection of the level of crowdedness, animal bodies are detected from a plurality of captured images of which imaging times are different. When a large number of animal bodies are detected, the level of crowdedness is set to be high. When a small number of animal bodies are detected, the level of crowdedness is set to be low. The crowdedness level detection unit 410 outputs the crowdedness level detection result to the threshold map generation unit 412.

The threshold storage unit 411 stores the human determination threshold in advance at each level of crowdedness. The threshold storage unit 411 outputs the human determination threshold in accordance with the level of crowdedness indicated in the threshold map generation unit 412 to the threshold map generation unit 412.

The threshold map generation unit 412 generates a threshold map in response to a user manipulation on the basis of a manipulation signal supplied from an input device 30. The threshold map generation unit 412 partitions a captured image generated by the imaging device 20 into a plurality of regions with different levels of crowdedness in response to a user manipulation. In addition, the threshold map generation unit 412 acquires the human determination threshold from the threshold storage unit 411 in response to a level of crowdedness designation manipulation on the partitioned regions by the user. The threshold map generation unit 412 generates, for example, a threshold map indicating a crowded region, an uncrowded region, and a human determination threshold for each region by causing the acquired human determination threshold to correspond to the partitioned region and outputs the threshold map to the human detection unit 421.

The human detection unit 421 performs the human detection using a captured image generated by the imaging device 20. In the human detection, a score indicating likelihood of humans is calculated. In addition, the human detection unit 421 compares the human determination threshold corresponding to a region with the score of the subject inside the region for each region indicated by the threshold map and determines that a subject with the score equal to or greater than the human determination threshold is a human. The human detection unit 421 outputs a human detection position indicating the position of the subject determined to be the human as a human detection result to the tracking unit 422.

The tracking unit 422 performs tracking of humans detected on the basis of the human detection result supplied from the human detection unit 421 and includes the tracking identification information allocated to the tracking frame in information indicating the predicted position of the tracking frame to output the tracking identification information as a tracking result to the threshold adjustment unit 413. In addition, the tracking unit 422 outputs the tracking result and the human detection result to the human detection reliability calculation unit 441.

The human detection reliability calculation unit 441 calculates the human detection reliability using the tracking result and the human detection result. The human detection reliability calculation unit 441 retains a history of the human detection result corresponding to the tracking frame for each piece of tracking identification information and calculates the human detection reliability for each piece of tracking identification information using the retained history. The human detection reliability calculation unit 441 outputs the human detection reliability calculated for each piece of tracking identification information to the counting unit 451.

The counting unit 451 determines the tracking frame passing the counting line which is a determination position on the basis of the tracking result supplied from the tracking unit 422. In addition, the counting unit 451 compares the human detection reliability corresponding to each tracking frame passing the counting line with the preset counting target determination threshold using the human detection reliability supplied from the human detection reliability calculation unit 441. Further, the counting unit 451 sets humans corresponding to the tracking frame in which the human detection reliability is equal to or greater than the counting target determination threshold as counting targets and performs human counting. The counting unit 451 outputs a human counting result to the output unit 461.

The output unit 461 causes the display device 50 to display the captured image generated by the imaging device 20. In addition, the output unit 461 causes the display device 50 to display the position of the counting line and the regions partitioned in response to a user manipulation so that the position of the counting lines or the regions can be identified. Further, the output unit 461 causes the display device 50 to display information regarding the result or the like acquired by the image processing device 40.

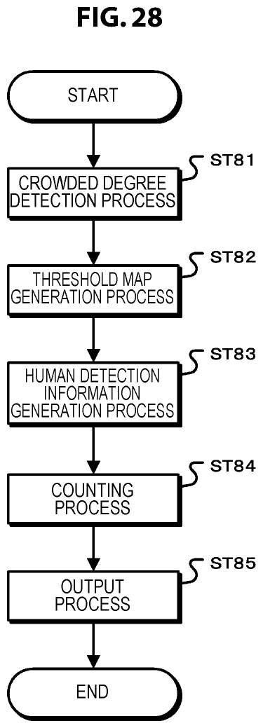

FIG. 28 is a flowchart illustrating an operation according to the other embodiment. In step ST81, the image processing device 40 performs a crowded degree detection process. The crowdedness level detection unit 410 of the image processing device 40 detects a level of crowdedness using the captured image generated by the imaging device 20, and then the process proceeds to step ST82.

In step ST82, the image processing device 40 performs the threshold map generation process. The threshold map generation unit 412 of the image processing device 40 partitions the captured image into the crowded region and the uncrowded region in accordance with the level of crowdedness detected in step ST81. Further, the threshold map generation unit 412 acquires the human determination threshold in accordance with the level of crowdedness of each region with regard to each of the crowded region and the uncrowded region from the threshold storage unit 411 and sets the human determination threshold in each region to generate the threshold map, and then the process proceeds to step ST83.

In step ST83, the image processing device 40 performs the human detection information generation process. The image processing device 40 performs the same process as step ST2 of FIG. 9. That is, the human detection unit 421 performs subject detection and generates a human detection result indicating a human detection position. In addition, the tracking unit 422 performs setting a tracking frame using the human detection result, predicts a position of the tracking frame in a subsequently acquired captured image from the image within the set tracking frame and the subsequently acquired captured image, and performs tracking of humans of the tracking frame. Further, the human detection reliability calculation unit 441 calculates the human detection reliability on the basis of the tracking result and the human detection result. The image processing device 40 sets the position of the tracking frame and the human detection reliability for each tracking frame as the human detection information, and then the process proceeds to step ST84.

In step ST84, the image processing device 40 performs the counting process. The counting unit 451 of the image processing device 40 performs the same process as step ST3 of FIG. 9 and determines the tracking frame passing the counting line from the position of the tracking frame in the human detection information generated in step ST83. Further, in the determined tracking frame, humans of the tracking frame in which the human detection reliability is equal to or greater than a preset counting target determination threshold are set as counting targets and the counting is performed to calculate the number of humans passing the counting line, and then the process proceeds to step ST85.

In step ST85, the image processing device 40 performs an output process. The output unit 461 of the image processing device 40 performs the same process as step ST4 of FIG. 9 and displays a counting process result obtained in step ST84.

According to the other embodiment, the crowded region and the uncrowded region are set from the captured image and the human determination threshold in accordance with the region is set automatically. Therefore, it is not necessary for a user to perform a manipulation of setting the regions or setting the level of crowdedness of the region and it is easy to use the image processing device. In addition, when the level of crowdedness of the region is changed, the human determination threshold can be optimized in accordance with the change. Thus, the precision of the human detection can be further improved than in a case in which the user sets the level of crowdedness.

In addition, when the third embodiment is applied to the above-described second embodiment, it is possible to obtain the human detection information with high reliability and high precision in either the case in which a human is moving from the uncrowded region to the crowded region and the case in which a human moving from the crowded region to the uncrowded region.

In addition, in the above-described embodiments, the cases in which the number of humans passing the counting line is measured have been described, but some of the processes of the above-described flowcharts can also be omitted in accordance with acquired information. For example, in a case in which information indicating a tracking result of the humans moving between the crowded region and the uncrowded region is acquired, the counting process can be omitted in the flowcharts illustrating the operations of the embodiments. In addition, in the output process, a tracking result with high reliability may also be displayed on the display device 50 on the basis of the human detection reliability information.

Further, a series of processing described herein can be executed by hardware, software, or the combination thereof. In a case of executing the processing by the software, the processing can be executed by installing the program in which the processing sequence is recorded in the memory of the computer embedded in the dedicated hardware, or can be executed by installing the program in the general-purpose computer that can execute various processing.

In one example, the program can be recorded previously on a hard disk, a solid-state drive (SSD), or a read only memory (ROM), as a recording medium. Alternatively, the program can be temporarily or permanently stored (recorded) in (on) a removable recording medium such as a flexible disk, a compact disc read only memory (CD-ROM), Magneto Optical (MO) disk, a digital versatile disc (DVD), a Blu-Ray Disc (registered trademark) (BD), a magnetic disk, or a semiconductor memory card. Such a removable recording medium can be provided as so-called package software.

In addition, the program can be, not only installed on a computer from a removable recording medium, but also transferred wirelessly or by wire to the computer from a download site via a network such as a local area network (LAN) or the Internet. In such a computer, a program transferred in the aforementioned manner can be received and installed on a recording medium such as built-in hardware.

Note that the effects described in the present specification are merely examples, not limitative; and additional effects that are not described may be exhibited. Furthermore, the present technology is not construed as being limited to the above-described embodiments of the technology. The embodiments of the technology disclose the present technology in the form of exemplification, and it is obvious that a person skilled in the art can make modification or substitution of the embodiments without departing from the gist of the present technology. In other words, in order to determine the gist of the present technology, the claims should be considered.

Additionally, the present technology may also be configured as below.

(1)

An image processing device including:

a threshold map generation unit configured to generate a threshold map in which a human determination threshold is set for each of a plurality of regions obtained by partitioning a captured image;

a human detection unit configured to perform human detection using the human determination threshold corresponding to the region for each of the plurality of regions on a basis of the threshold map generated by the threshold map generation unit;

a tracking unit configured to perform tracking of humans detected by the human detection unit; and

a human detection reliability calculation unit configured to calculate human detection reliability for each of the detected humans by using a human detection result of the human detection unit and a tracking result of the tracking unit.

(2)

The image processing device according to (1),

in which the captured image is partitioned into a crowded region and an uncrowded region, and the human determination threshold is set in accordance with levels of crowdedness of the regions.

(3)

The image processing device according to (2),

in which the human determination threshold of the crowded region is set such that a precision ratio indicating to what extent humans of the crowded region are included in the humans detected through the human detection is maximum in a state in which a recall ratio indicating to what extent the humans detected through the human detection are included in the humans of the crowded region is maintained at a predetermined level.

(4)

The image processing device according to (2) or (3),

in which the human determination threshold of the uncrowded region is set such that a precision ratio indicating to what extent humans of the uncrowded region are included in the humans detected through the human detection is equal to or greater than a predetermined level and a recall ratio indicating to what extent the humans detected through the human detection are included in the humans of the uncrowded region is maximum.

(5)

The image processing device according to any of (1) to (4),

in which the human detection unit calculates a score indicating accuracy of the humans with regard to a subject and determines that the subject is a human when the calculated score is equal to or greater than the human determination threshold corresponding to a position of the subject.

(6)

The image processing device according to any of (1) to (5),

in which the tracking unit sets tracking frames on the humans detected by the human detection unit and predicts positions of the tracking frames in a captured image having a different imaging time from images within the tracking frames, by using the captured image having the different imaging time.

(7)

The image processing device according to (6),

in which the tracking unit sets different pieces of tracking identification information for each human with regard to the tracking frames, predicts a position of the tracking frame for each piece of the tracking identification information, and includes the piece of the tracking identification information set in the tracking frame at the predicted position in information indicating a human detection result obtained by the human detection unit within a human position assumption region corresponding to the tracking frame at the predicted position.

(8)

The image processing device according to any of (1) to (7),

in which the human detection reliability calculation unit calculates a human detection situation at a tracked position during a reliability calculation period and sets the calculated human detection situation as the human detection reliability.

(9)

The image processing device according to (2), further including:

a threshold adjustment unit configured to adjust the human determination threshold of a predetermined region in which a predicted position of a human in the threshold map serves as a reference such that it becomes easier to determine the human than before the adjustment, when the human detected in the uncrowded region is tracked and the predicted position of the human is in the crowded region.

(10)

The image processing device according to (2) or (9), further including:

a backtracking unit configured to adjust the human determination threshold of a predetermined region in which a predicted position of a human in the threshold map serves as a reference such that it becomes easier to determine the human than before the adjustment, when tracking and human detection are performed on the human detected in the uncrowded region in a past direction and the predicted position of the human in the tracking is in the crowded region, and configured to perform the human detection using the adjusted human determination threshold.

(11)

The image processing device according to (10),

in which the human detection reliability calculation unit calculates the human detection reliability by using a tracking result and a human detection result acquired by the backtracking unit.

(12)

The image processing device according to (3), further including:

a threshold learning unit configured to learn the human determination threshold for each region by using learning images of the crowded region and the uncrowded region,

in which the threshold learning unit sets a threshold at which the recall ratio is equal to or greater than a predetermined level and the precision ratio is highest as the human determination threshold in the crowded region, and sets a threshold at which the precision ratio is equal to or greater than a predetermined level and the recall ratio is highest or a threshold at which both the recall ratio and the precision ratio are high as the human determination threshold in the uncrowded region.

(13)

The image processing device according to (2),

in which the threshold map generation unit generates the threshold map in accordance with the preset crowded region, the preset uncrowded region, and a level of crowdedness of the crowded region.

(14)

The image processing device according to (2), further including:

a crowdedness level detection unit configured to detect a level of crowdedness by using the captured image,

in which the threshold map generation unit performs the partitioning into the crowded region and the uncrowded region on a basis of the level of crowdedness detected by the crowdedness level detection unit, and generates the threshold map in accordance with the levels of crowdedness for the respective partitioned regions.

(15)

The image processing device according to any of (1) to (14), further including:

a counting unit configured to set humans whose human detection reliability is equal to or greater than a counting target determination threshold and who pass a preset determination position as counting targets on a basis of the human detection reliability calculated by the human detection reliability calculation unit and a tracking result of the tracking unit, and configured to count a number of the humans passing the determination position.

### INDUSTRIAL APPLICABILITY

In an image processing device, an image processing method, and a program of the present technology, a threshold map in which a human determination threshold is set is generated for each of a plurality of regions obtained by partitioning a captured image, and human detection is performed for each of the plurality of regions using the human determination threshold corresponding to the region for each of the regions based on the threshold map. In addition, tracking of the detected humans is performed and the human detection reliability is calculated for each of the detected humans using the human detection result and the tracking result. Therefore, it is possible to obtain human detection information with high reliability and high precision. Accordingly, for example, the number of passengers can be measured from a captured image of a surveillance camera or the like with high precision.

### REFERENCE SIGNS LIST

10 image processing system
20 imaging device
30 input device
40 image processing device
50 display device
401 learning image group storage unit
402 threshold learning unit
410 crowdedness level detection unit
411 threshold storage unit
412 threshold map generation unit
413 threshold adjustment unit
421 human detection unit
422, 423 tracking unit
431 previous image storage unit
432 backtracking unit
4321 past image selection unit
4322 threshold adjustment unit
4323 human detection unit
4324 tracking unit
441, 442 human detection reliability calculation unit
451 counting unit
461 output unit

1. An image processing device comprising:
a threshold map generation unit configured to generate a threshold map in which a human determination threshold is set for each of a plurality of regions obtained by partitioning a captured image;
a human detection unit configured to perform human detection using the human determination threshold corresponding to the region for each of the plurality of regions on a basis of the threshold map generated by the threshold map generation unit;
a tracking unit configured to perform tracking of humans detected by the human detection unit; and
a human detection reliability calculation unit configured to calculate human detection reliability for each of the detected humans by using a human detection result of the human detection unit and a tracking result of the tracking unit.

2. The image processing device according to claim 1,
wherein the captured image is partitioned into a crowded region and an uncrowded region, and the human determination threshold is set in accordance with levels of crowdedness of the regions.

3. The image processing device according to claim 2,
wherein the human determination threshold of the crowded region is set such that a precision ratio indicating to what extent humans of the crowded region are included in the humans detected through the human detection is maximum in a state in which a recall ratio indicating to what extent the humans detected through the human detection are included in the humans of the crowded region is maintained at a predetermined level.

4. The image processing device according to claim 2,
wherein the human determination threshold of the uncrowded region is set such that a precision ratio indicating to what extent humans of the uncrowded region are included in the humans detected through the human detection is equal to or greater than a predetermined level and a recall ratio indicating to what extent the humans detected through the human detection are included in the humans of the uncrowded region is maximum.

5. The image processing device according to claim 1,
wherein the human detection unit calculates a score indicating accuracy of the humans with regard to a subject and determines that the subject is a human when the calculated score is equal to or greater than the human determination threshold corresponding to a position of the subject.

6. The image processing device according to claim 1,
wherein the tracking unit sets tracking frames on the humans detected by the human detection unit and predicts positions of the tracking frames in a captured image having a different imaging time from images within the tracking frames, by using the captured image having the different imaging time.

7. The image processing device according to claim 6,
wherein the tracking unit sets different pieces of tracking identification information for each human with regard to the tracking frames, predicts a position of the tracking frame for each piece of the tracking identification information, and includes the piece of the tracking identification information set in the tracking frame at the predicted position in information indicating a human detection result obtained by the human detection unit within a human position assumption region corresponding to the tracking frame at the predicted position.

8. The image processing device according to claim 1,
wherein the human detection reliability calculation unit calculates a human detection situation at a tracked position during a reliability calculation period and sets the calculated human detection situation as the human detection reliability.

9. The image processing device according to claim 2, further comprising:
a threshold adjustment unit configured to adjust the human determination threshold of a predetermined region in which a predicted position of a human in the threshold map serves as a reference such that it becomes easier to determine the human than before the adjustment, when the human detected in the uncrowded region is tracked and the predicted position of the human is in the crowded region.

10. The image processing device according to claim 2, further comprising:
a backtracking unit configured to adjust the human determination threshold of a predetermined region in which a predicted position of a human in the threshold map serves as a reference such that it becomes easier to determine the human than before the adjustment, when tracking and human detection are performed on the human detected in the uncrowded region in a past direction and the predicted position of the human in the tracking is in the crowded region, and configured to perform the human detection using the adjusted human determination threshold.

11. The image processing device according to claim 10,
wherein the human detection reliability calculation unit calculates the human detection reliability by using a tracking result and a human detection result acquired by the backtracking unit.

12. The image processing device according to claim 3, further comprising:
a threshold learning unit configured to learn the human determination threshold for each region by using learning images of the crowded region and the uncrowded region,
wherein the threshold learning unit sets a threshold at which the recall ratio is equal to or greater than a predetermined level and the precision ratio is highest as the human determination threshold in the crowded region, and sets a threshold at which the precision ratio is equal to or greater than a predetermined level and the recall ratio is highest or a threshold at which both the recall ratio and the precision ratio are high as the human determination threshold in the uncrowded region.

13. The image processing device according to claim 2,
wherein the threshold map generation unit generates the threshold map in accordance with the preset crowded region, the preset uncrowded region, and a level of crowdedness of the crowded region.

14. The image processing device according to claim 2, further comprising:
a crowdedness level detection unit configured to detect a level of crowdedness by using the captured image,
wherein the threshold map generation unit performs the partitioning into the crowded region and the uncrowded region on a basis of the level of crowdedness detected by the crowdedness level detection unit, and generates the threshold map in accordance with the levels of crowdedness for the respective partitioned regions.

15. The image processing device according to claim 1, further comprising:
a counting unit configured to set humans whose human detection reliability is equal to or greater than a counting target determination threshold and who pass a preset determination position as counting targets on a basis of the human detection reliability calculated by the human detection reliability calculation unit and a tracking result of the tracking unit, and configured to count a number of the humans passing the determination position.

16. An image processing method comprising:
generating, by a threshold map generation unit, a threshold map in which a human determination threshold is set for each of a plurality of regions obtained by partitioning a captured image;
performing, by a human detection unit, human detection using the human determination threshold corresponding to the region for each of the plurality of regions on a basis of the threshold map generated by the threshold map generation unit;
performing, by a tracking unit, tracking of humans detected by the human detection unit; and
calculating, by a human detection reliability calculation unit, human detection reliability for each of the detected humans by using a human detection result of the human detection unit and a tracking result of the tracking unit.

17. A program causing a computer to perform image processing, the program causing the computer to perform:
a procedure for generating a threshold map in which a human determination threshold is set for each of a plurality of regions obtained by partitioning a captured image;
a procedure for performing human detection using the human determination threshold corresponding to the region for each of the plurality of regions on a basis of the generated threshold map;
a procedure for performing tracking of the detected humans; and
a procedure for calculating human detection reliability for each of the detected humans by using a result of the human detection and a result of the tracking.
